(19) United States
(12) Patent Application Publication
(10) Pub. No.: US 2015/0003347 A1
(43) Pub. Date: Jan. 1, 2015

(54) METHOD AND APPARATUS FOR TRANSCEIVING UPLINK CONTROL INFORMATION IN A WIRELESS COMMUNICATION SYSTEM

(71) Applicant: LG ELECTRONICS INC., Seoul (KR)

(72) Inventors: Hyunsoo Ko, Anyang-si (KR); Jaehoon Chung, Anyang-si (KR)

(73) Assignee: LG ELECTRONICS INC., Seoul (KR)

(21) Appl. No.: 14/342,732

(22) PCT Filed: Oct. 10, 2012
(86) PCT No.: PCT/KR2012/008200

§ 371 Date: Mar. 4, 2014

Related U.S. Application Data
(60) Provisional application No. 61/545,565, filed on Oct. 10, 2011.

(51) Int. Cl. H04W 72/04; H04L 5/00

(52) U.S. Cl. CPC H04W 72/0413; H04L 5/0055
USPC 370/329

(57) ABSTRACT

The present invention relates to a wireless communication system, and more specifically, to a method and apparatus for reporting channel state information. A method in which a terminal transmits uplink control information (UCI) in a wireless communication system according to one embodiment of the present invention comprises: a step of determining channel state information (CSI) report timing; a step of determining acknowledgement/non-acknowledgement (ACK/NACK) information transmission timing; and a step of transmitting one or more pieces of the CSI or the ACK/NACK information via an uplink subframe. In the event that the CSI is invalid CSI, then said CSI is omitted, and only said ACK/NACK information can be transmitted via the uplink subframe.

### TECHNICAL FIELD

The following description relates to a wireless communication system and, more particularly, to a method and apparatus for transmitting/receiving uplink control information.

### BACKGROUND ART

MIMO (multiple-input multiple-output) refers to a method for improving transmission/reception efficiency by adopting multiple transmit (Tx) antennas and multiple receive (Rx) antennas. That is, MIMO is a technology for increasing capacity or improving performance by using multiple antennas at a transmitting end or a receiving end of a wireless communication system. MIMO may be referred to as multi-antenna technology. To correctly perform multi-antenna transmission, it is necessary to feed back information on a channel from a receiving end that receives multiple antenna channels. The feedback information may include channel state information (CSI) such as a rank indicator (RI), a precoding matrix index (PMI), a channel quality indicator (CQI), etc. about a downlink channel.

Hybrid automatic repeat request (HARQ) acknowledgement/negative-acknowledgement (ACK/NACK) information representing whether a receiving end has successfully decoded data transmitted from a transmitting end can be transmitted from the receiving end to the transmitting end in a wireless communication system. For example, an error detection code (e.g. CRC (cyclic redundancy check)) can be added to data transmitted from the transmitting end per codeword, and thus the receiving end can generate ACK/NACK information per codeword. Whether or not a single codeword has been successfully decoded can be represented as 1-bit ACK/NACK information.

In addition, scheduling information (SR) used for a UE to request a base station to provide scheduling information for uplink transmission can be transmitted from the UE to the base station.

The above-described control information such as CSI, ACK/NACK, SR, etc. can be referred to as uplink control information (UCI). The UCI can be transmitted on a physical uplink control channel (PUCCH) or physical uplink shared channel (PUSCH).

### DISCLOSURE

### Technical Problem

In periodic reporting of CSI through a PUCCH, CSI (e.g. a first PMI) which is a basis of calculation/determination of another piece of CSI (e.g. a second PMI) may not be reported. Whether or not invalid CSI (the second PMI) needs to be reported in this case has not been determined yet. Furthermore, CSI reporting through a PUCCH and ACK/NACK transmission through a PUCCH may be performed at the same timing. A UCI transmission operation when invalid CSI reporting timing and ACK/NACK transmission timing overlap (i.e. collide) has not been determined yet.

An object of the present invention devised to solve the problem lies in a method and apparatus for correctly and efficiently transmitting/receiving UCI by defining a rule for simultaneous transmission of CSI and ACK/NACK.

The technical problems solved by the present invention are not limited to the above technical problems and those skilled in the art may understand other technical problems from the following description.

### Technical Solution

The object of the present invention can be achieved by providing a method for transmitting uplink control information (UCI) by user equipment (UE) in a wireless communication system, including: determining timing of transmitting channel state information (CSI); determining timing of transmitting acknowledgement/negative-acknowledgement (ACK/NACK) information; and transmitting one or more of the CSI and ACK/NACK information through an uplink subframe, wherein, when the CSI is invalid CSI, the CSI is dropped and only the ACK/NACK information is transmitted through the uplink subframe.

In another embodiment of the present invention, provided herein is a UE for reporting UCI in a wireless communication system, including: a reception module for receiving a downlink signal from a base station; a transmission module for transmitting an uplink signal to the base station; and a processor for controlling the UE including the reception module and the transmission module, wherein the processor is configured to determine timing of transmitting (CSI), to determine timing of transmitting ACK/NACK information and to transmit one or more of the CSI and ACK/NACK information through an uplink subframe, wherein, when the CSI is invalid CSI, the CSI is dropped and only the ACK/NACK information is transmitted through the uplink subframe.

The following may be commonly applied to the above-described embodiments of the present invention.

The UCI may be transmitted using a physical uplink control channel (PUCCH).

PUCCH format 2a, 2b or 3 may be used when the CSI is dropped and only the ACK/NACK information is transmitted.

The invalid CSI may correspond to a wideband second precoding matrix indicator (PMI) and wideband channel quality indicator (CQI) reported when a wideband first PMI is not reported after reporting of a rank indicator (RI) corresponding to a precoding type indicator (PTI) of 0.

A rank value in the RI reporting may be changed from a rank value in previous rank reporting.

The CSI may be periodically reported.

Simultaneous transmission of the CSI and ACK/NACK information may be set by a higher layer for the UE.

The above description and the following description are exemplary and are for additional explanation of claims.

### Advantageous Effects

According to the present invention, it is possible to provide a method and apparatus for correctly and efficiently transmitting/receiving UCI by defining a rule for simultaneous transmission of CSI and ACK/NACK.

The effects of the present invention are not limited to the above-described effects and other effects which are not described herein will become apparent to those skilled in the art from the following description.

### DESCRIPTION OF DRAWINGS

The accompanying drawings, which are included to provide a further understanding of the invention, illustrate embodiments of the invention and together with the description serve to explain the principle of the invention. In the drawings:

FIG. 1 illustrates a radio frame structure;

FIG. 2 illustrates a resource grid in a downlink slot;

FIG. 3 illustrates a downlink subframe structure;

FIG. 4 illustrates an uplink subframe structure;

FIG. 5 illustrates a wireless communication system having multiple antennas;

FIG. 6 illustrates mapping of PUCCH formats to PUCCH regions in an uplink physical resource block;

FIG. 7 illustrates determination of PUCCH resources for ACK/NACK;

FIG. 8 illustrates an ACK/NACK channel structure in a normal CP case;

FIG. 9 illustrates a CQI channel structure in a normal CP case;

FIG. 10 illustrates PUCCH structures using block spreading;

FIG. 11 illustrates a feedback structure according to PUCCH reporting mode 2-1 when PTI=0;

FIG. 12 illustrates a feedback structure according to PUCCH reporting mode 2-1 when PTI=1;

FIG. 13 illustrates an example of PUCCH reporting mode 2-1 according to H (i.e. H0) when PTI=0;

FIG. 14 illustrates another example of PUCCH reporting mode 2-1 according to He (i.e. H0) when PTI=0;

FIG. 15 illustrates exemplary CSI reporting timing and ACK/NACK reporting timing;

FIG. 16 illustrates examples of transmitting invalid CSI and ACK/NACK according to the present invention;

FIG. 17 is a flowchart illustrating a method for transmitting uplink control information according to an embodiment of the present invention; and

FIG. 18 illustrates a configuration of a transceiver according to an embodiment of the present invention.

### BEST MODE

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment.

In the embodiments of the present invention, a description is made, centering on a data transmission and reception relationship between a base station (BS) and a user equipment (UE). The BS is a terminal node of a network, which communicates directly with a UE. In some cases, a specific operation described as performed by the BS may be performed by an upper node of the BS.

Namely, it is apparent that, in a network comprised of a plurality of network nodes including a BS, various operations performed for communication with a UE may be performed by the BS, or network nodes other than the BS. The term ‘BS’ may be replaced with the term ‘fixed station’, ‘Node B’, ‘evolved Node B (eNode B or eNB)’, ‘Access Point (AP)’, etc. The term ‘UE’ may be replaced with the term ‘terminal’, ‘Mobile Station (MS)’, ‘Mobile Subscriber Station (MSS)’, ‘Subscriber Station (SS)’, etc.

Specific terms used for the embodiments of the present invention are provided to help the understanding of the present invention. These specific terms may be replaced with other terms within the scope and spirit of the present invention.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

The embodiments of the present invention can be supported by standard documents disclosed for at least one of wireless access systems, Institute of Electrical and Electronics Engineers (IEEE) 802, 3^{rd} Generation Partnership Project (3GPP), 3GPP Long Term Evolution (3GPP LTE), LTE-Advanced (LTE-A), and 3GPP2. Steps or parts that are not described to clarify the technical features of the present invention can be supported by those documents. Further, all terms as set forth herein can be explained by the standard documents.

Techniques described herein can be used in various wireless access systems such as Code Division Multiple Access (CDMA), Frequency Division Multiple Access (FDMA), Time Division Multiple Access (TDMA), Orthogonal Frequency Division Multiple Access (OFDMA), Single Carrier-Frequency Division Multiple Access (SC-FDMA), etc. CDMA may be implemented as a radio technology such as Universal Terrestrial Radio Access (UTRA) or CDMA2000. TDMA may be implemented as a radio technology such as Global System for Mobile communications (GSM)/General Packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved-UTRA (E-UTRA) etc. UTRA is a part of Universal Mobile Telecommunication System (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. WiMAX can be described by the IEEE 802.16e standard (Wireless Metropolitan Area Network (WirelessMAN-OFDMA Reference System) and the IEEE 802.16m standard (WirelessMAN-OFDMA Advanced System). For clarity, this application focuses on the 3GPP LTE/LTE-A system. However, the technical features of the present invention are not limited thereto.

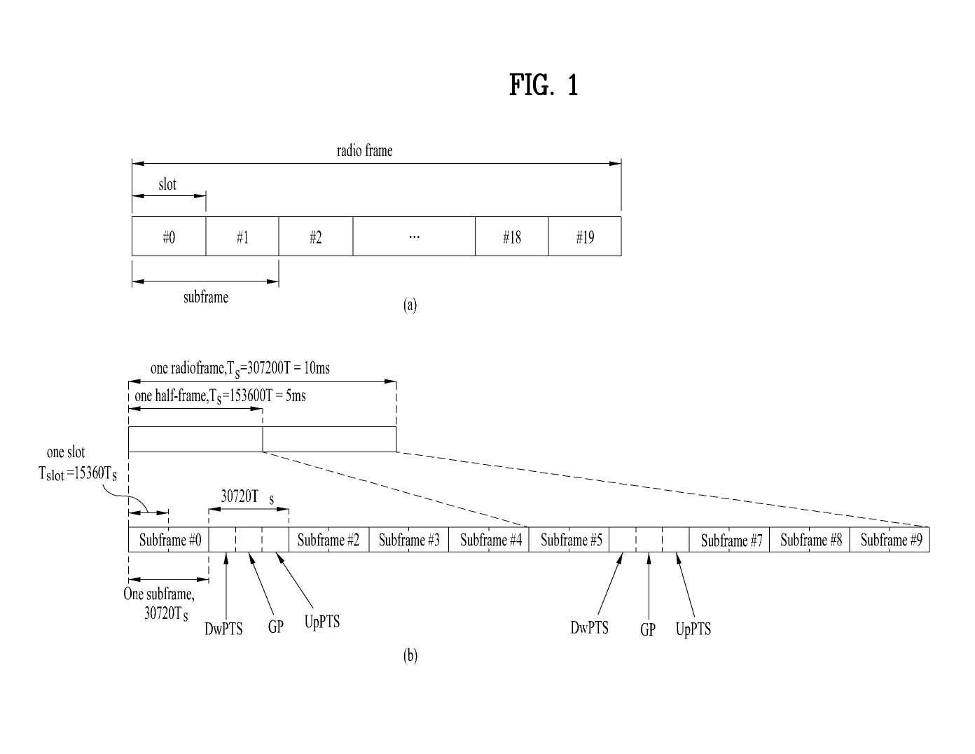

A description will be given of a downlink radio frame structure with reference to FIG. 1.

In a cellular OFDM wireless packet communication system, uplink/downlink data packet transmission is performed on a subframe-by-subframe basis and one subframe is defined as a predetermined time interval including a plurality of OFDM symbols. 3GPP LTE supports type-1 radio frame applicable to FDD (frequency division duplex) and type-2 radio frame applicable to TDD (time division duplex).

FIG. 1(a) illustrates a type-1 radio frame structure. A downlink radio frame includes 10 subframes. Each subframe is further divided into two slots in the time domain. A unit time during which one subframe is transmitted is defined as transmission time interval (TTI). For example, one subframe may be lms in duration and one slot may be 0.5 ms in duration. A slot may include a plurality of OFDM symbols in the time domain and a plurality of resource blocks (RBs) in the frequency domain. Since 3GPP LTE adopts OFDMA for downlink, an OFDM symbol represents one symbol period. An OFDM symbol may be referred to as an SC-FDMA symbol or symbol period. A resource block (RB) is a resource allocation unit including a plurality of contiguous subcarriers in a slot.

The number of OFDM symbols included in one slot may depend on cyclic prefix (CP) configuration. CPs include an extended CP and a normal CP. When an OFDM symbol is configured with the normal CP, for example, the number of OFDM symbols included in one slot may be 7. When an OFDM symbol is configured with the extended CP, the duration of one OFDM symbol increases, and thus the number of OFDM symbols included in one slot is smaller than that in case of the normal CP. In case of the extended CP, the number of OFDM symbols allocated to one slot may be 6. When a channel state is unstable, such as a case in which a UE moves at a high speed, the extended CP can be used to reduce inter-symbol interference.

When the normal CP is used, one subframe includes 14 OFDM symbols since one slot has 7 OFDM symbols. The first two or three OFDM symbols in each subframe can be allocated to a PDCCH and the remaining OFDM symbols can be allocated to a PDSCH.

FIG. 1(b) illustrates a type-2 radio frame structure. The type-2 radio frame includes 2 half frames. Each half frame includes 5 subframes, a downlink pilot time slot (DwPTS), a guard period (GP) and an uplink pilot time slot (UpPTS). One subframe consists of 2 slots. The DwPTS is used for initial cell search, synchronization or channel estimation in a UE. The UpPTS is used for channel estimation in a BS and UL transmission synchronization acquisition in a UE. The GP eliminates UL interference caused by multi-path delay of a DL signal between a UL and a DL. One subframe includes 2 slots irrespective of radio frame type.

This radio frame structure is purely exemplary and thus the number of subframes in a radio frame, the number of slots in a subframe, or the number of OFDM symbols in a slot may vary.

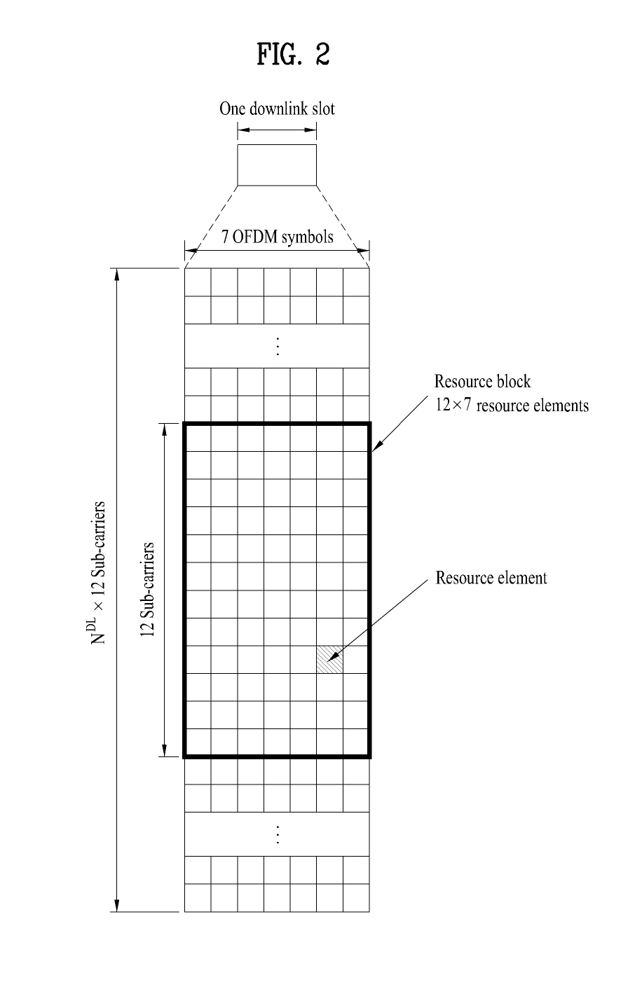

FIG. 2 illustrates a resource grid in a downlink slot. While one downlink slot includes 7 OFDM symbols in the time domain and one RB includes 12 subcarriers in the frequency domain in FIG. 2, the present invention is not limited thereto. For example, one slot includes 7 OFDM symbols in the case of normal CP whereas one slot includes 6 OFDM symbols in the case of extended CP. Each element on the resource grid is referred to as a resource element (RE). One RB includes 12×7(6) REs. The number N^{DL} of RBs included in the downlink slot depends on a downlink transmit bandwidth. The structure of an uplink slot may be same as that of the downlink slot.

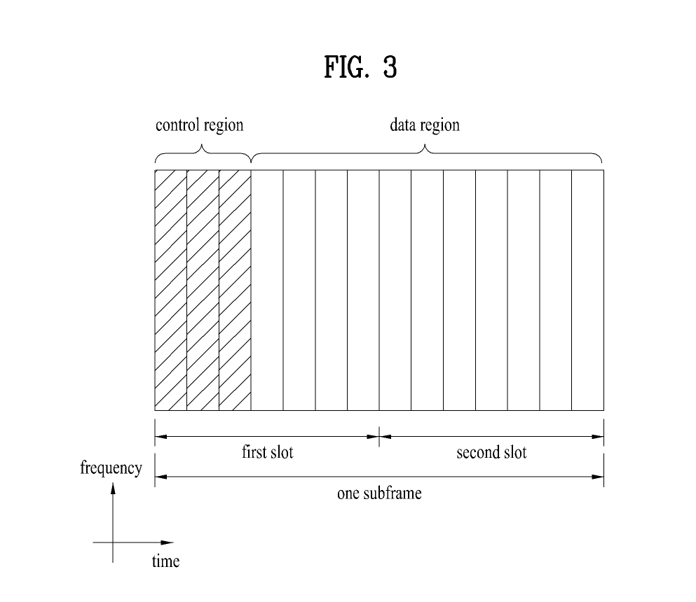

FIG. 3 illustrates a downlink subframe structure. A maximum of three OFDM symbols located in a front portion of a first slot within a subframe correspond to a control region to which a control channel is allocated. The remaining OFDM symbols correspond to a data region to which a physical downlink shared chancel (PDSCH) is allocated. Examples of downlink control channels used in 3GPP LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/negative-acknowledgment (NACK) signal. Control information transmitted through the PDCCH is referred to as downlink control information (DCI). The DCI includes uplink or downlink scheduling information or uplink Tx power control commands for an arbitrary UE group. The PDCCH may carry a transport format and a resource allocation of a downlink shared channel (DL-SCH), resource allocation information of an uplink shared channel (UL-SCH), paging information on a paging channel (PCH), system information on the DL-SCH, information on resource allocation of an upper-layer control message such as a random access response transmitted on the PDSCH, a set of Tx power control commands on individual UEs within an arbitrary UE group, a Tx power control command, information on activation of a voice over IP (VoIP), etc. A plurality of PDCCHs can be transmitted within a control region. The UE can monitor the plurality of PDCCHs. The PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). A format of the PDCCH and the number of bits of the available PDCCH are determined by the number of CCEs. The BS determines a PDCCH format according to DCI to be transmitted to the UE, and attaches a cyclic redundancy check (CRC) to control information. The CRC is masked with an identifier referred to as a radio network temporary identifier (RNTI) according to an owner or usage of the PDCCH. If the PDCCH is for a specific UE, a cell-RNTI (C-RNTI)) of the UE may be masked to the CRC. Alternatively, when the PDCCH is for a paging message, a paging indicator identifier (P-RNTI) may be masked to the CRC. When the PDCCH is for system information (more specifically, a system information block (SIB)), a system information identifier and system information RNTI (SI-RNTI) may be masked to the CRC. To indicate a random access response corresponding to a response to transmission of a random access preamble of the UE, a random access-RNTI (RA-RNTI) may be masked to the CRC.

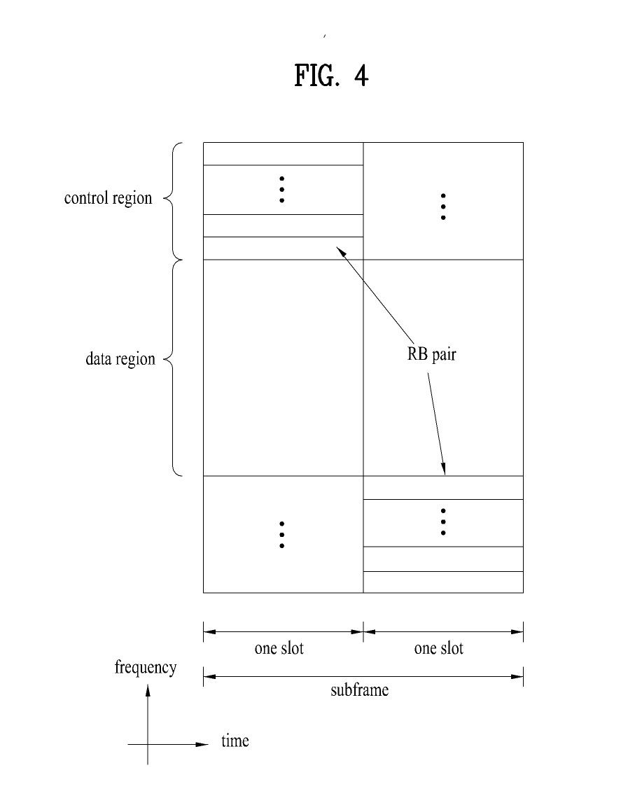

FIG. 4 illustrates an uplink subframe structure. An uplink subframe may be divided into a control region and a data region in the frequency domain. The control region is allocated a PUCCH including uplink control information. The data region is allocated a PUSCH including user data. To maintain single carrier property, one UE cannot simultaneously transmit a PUCCH and a PUSCH. A PUCCH for a UE is allocated to an RB pair. RBs belonging to an RB pair occupy different subcarriers in 2 slots. That is, an RB pair allocated to a PUCCH is frequency-hopped at a slot boundary.

MIMO System

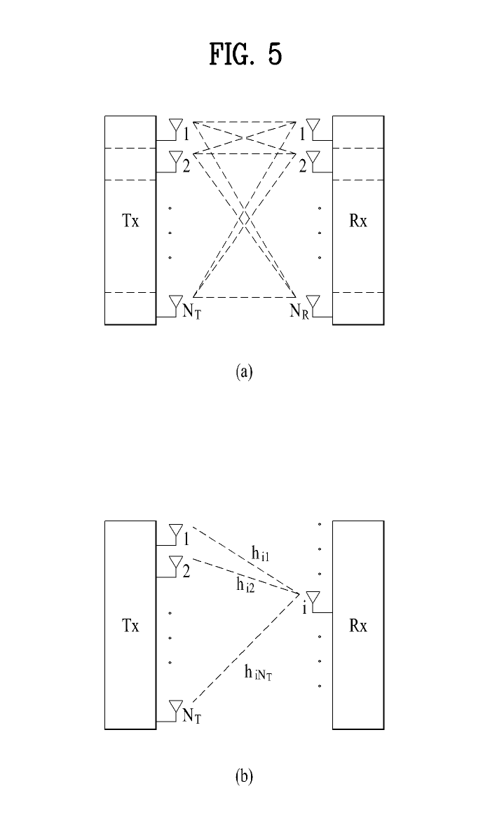

FIG. 5 shows the configuration of a wireless communication system including multiple antennas.

Referring to FIG. 5(a), if the number of transmit (Tx) antennas increases to N_{T}, and at the same time the number of receive (Rx) antennas increases to N_{R}, a theoretical channel transmission capacity of the MIMO communication system increases in proportion to the number of antennas, differently from the above-mentioned case in which only a transmitter or receiver uses several antennas, so that transmission rate and frequency efficiency can be greatly increased. In this case, the transfer rate acquired by the increasing channel transmission capacity can theoretically increase by a predetermined amount that corresponds to multiplication of a maximum transfer rate (Rₒ) acquired when one antenna is used and a rate of increase (Rᵢ). The rate of increase (Rᵢ) can be represented by the following equation 1.

Rᵢ=min(N_{T},N_{R}) [Equation 1]

For example, provided that a MIMO system uses four Tx antennas and four Rx antennas, the MIMO system can theoretically acquire a high transfer rate which is four times higher than that of a single antenna system. After the above-mentioned theoretical capacity increase of the MIMO system was demonstrated in the mid-1990s, many developers began to conduct intensive research into a variety of technologies which can substantially increase data transfer rate using the theoretical capacity increase. Some of the above technologies have been reflected in a variety of wireless communication standards, for example, third-generation mobile communication or next-generation wireless LAN, etc.

A variety of MIMO-associated technologies have been intensively researched by many companies or developers, for example, research into information theory associated with MIMO communication capacity under various channel environments or multiple access environments, research into a radio frequency (RF) channel measurement and modeling of the MIMO system, and research into a space-time signal processing technology.

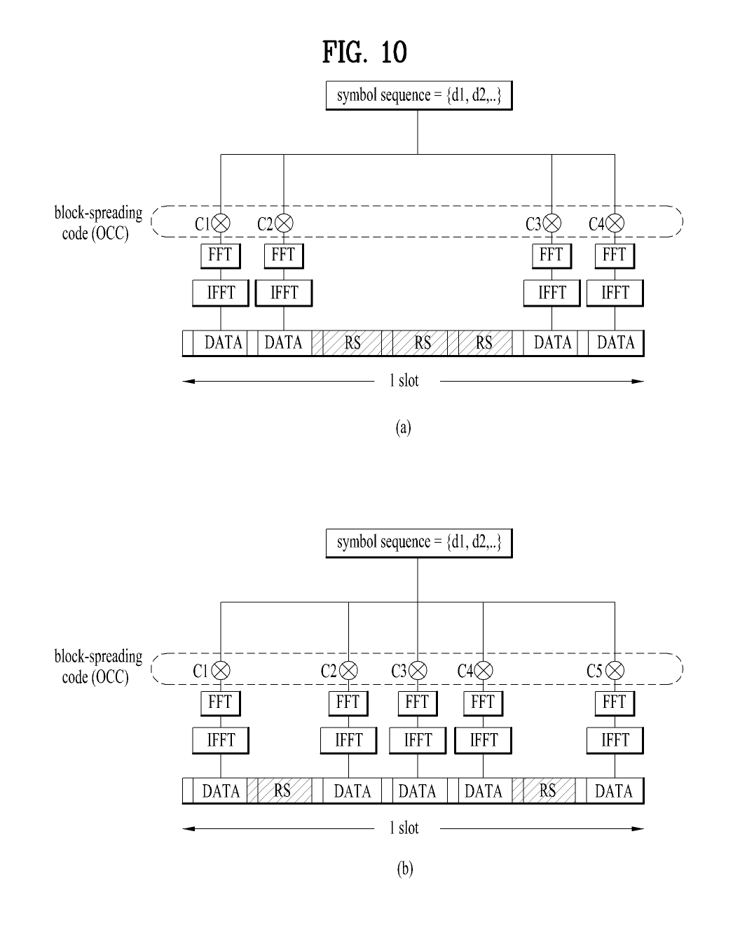

Mathematical modeling of a communication method for use in the above-mentioned MIMO system will hereinafter be described in detail. As can be seen from FIG. 10(a), it is assumed that there are N_{T} Tx antennas and N_{R} Rx antennas. In the case of a transmission signal, a maximum number of transmission information pieces is N_{T} under the condition that N_{T} Tx antennas are used, so that the transmission information can be represented by a specific vector shown in the following equation 2.

s└s₁,s₂, . . . ,s_{N}_{_{T}}┘^{T} [Equation 2]

In the meantime, individual transmission information pieces s₁, s₂, . . . s_{NT} may have different transmission powers. In this case, if the individual transmission powers are denoted by P₁, P₂, . . . , P_{NT}, transmission information having an adjusted transmission power can be represented by a specific vector shown in the following equation 3.

ŝ=[ŝ₁,ŝ₂, . . . ,ŝ_{N}_{_{T}}]^{T}=[P₁s₁,P₂s₂, . . . ,P_{N}_{_{T}}s_{N}_{_{T}}]^{T} [Equation 3]

In Equation 3, Ŝ is a transmission vector, and can be represented by the following equation 4 using a diagonal matrix P of a transmission power.

$$\hat{s} = [ \begin{matrix} {P}_{ 1} & & & 0 \\ & {P}_{ 2} & & \\ & & ⋱ & \\ 0 & & & {P}_{ {N}_{ T}}\end{matrix} ] [ \begin{matrix} {s}_{ 1} \\ {s}_{ 2} \\ ⋮ \\ {s}_{ {N}_{ T}}\end{matrix} ] = Ps \qquad [ Equation 4 ]$$

In the meantime, the information vector Ŝ having an adjusted transmission power is applied to a weight matrix W, so that N_{T} transmission signals x₁, x₂, . . . , x_{NT} to be actually transmitted are configured. In this case, the weight matrix W is adapted to properly distribute transmission information to individual antennas according to transmission channel situations. The above-mentioned transmission signals x₁, x₂, . . . , x_{NT} can be represented by the following equation 5 using the vector X. Here, Wᵢⱼ denotes a weight corresponding to i-th Tx antenna and j-th information. W represents a weight matrix or precoding matrix.

$$\begin{matrix}x = [ \begin{matrix}{x}_{1} \\ {x}_{2} \\ ⋮ \\ {x}_{i} \\ ⋮ \\ {x}_{{N}_{T}}\end{matrix} ] \\ = [ \begin{matrix}{w}_{11} & {w}_{12} & … & {w}_{1 {N}_{T}} \\ {w}_{21} & {w}_{22} & … & {w}_{2 {N}_{T}} \\ ⋮ & & ⋱ & \\ {w}_{i 1} & {w}_{i 2} & … & {w}_{{iN}_{T}} \\ ⋮ & & ⋱ & \\ {w}_{{N}_{T} 1} & {w}_{{N}_{T} 2} & … & {w}_{{N}_{T} {N}_{T}}\end{matrix} ] [ \begin{matrix}{\hat{s}}_{1} \\ {\hat{s}}_{2} \\ ⋮ \\ {\hat{s}}_{j} \\ ⋮ \\ {\hat{s}}_{{N}_{T}}\end{matrix} ] \\ = W \hat{s} \\ = WPs\end{matrix} \qquad [ Equation 5 ]$$

When N_{R} Rx antennas are used, received signals y₁, y₂, . . . , y_{NR} of individual antennas can be represented by a specific vector (y) shown in the following equation 6.

y=[y₁,y₂, . . . ,y_{N}_{_{R]}}^{T} [Equation 6]

In the meantime, if a channel modeling is executed in the MIMO communication system, individual channels can be distinguished from each other according to Tx/Rx antenna indexes. A specific channel passing the range from a Tx antenna j to a Rx antenna i is denoted by hᵢⱼ. In this case, it should be noted that the index order of the channel hᵢⱼ is located before a Rx antenna index and is located after a Tx antenna index.

Several channels are tied up, so that they are displayed in the form of a vector or matrix. An exemplary vector is as follows. FIG. 5(b) shows channels from N_{T} Tx antennas to a Rx antenna i.

Referring to FIG. 5(b), the channels passing the range from the N_{T} Tx antennas to the Rx antenna i can be represented by the following equation 7.

hᵢ^{T}=└hᵢ₁,hᵢ₂, . . . h_{iN}_{_{T}}┘ [Equation 7]

If all channels passing the range from the N_{T} Tx antennas to N_{R} Rx antennas are denoted by the matrix shown in Equation 7, the following equation 8 is acquired.

$$H = [ \begin{matrix}{h}_{1}^{T} \\ {h}_{2}^{T} \\ ⋮ \\ {h}_{i}^{T} \\ ⋮ \\ {h}_{{N}_{R}}^{T}\end{matrix} ] = [ \begin{matrix}{h}_{11} & {h}_{12} & … & {h}_{1 {N}_{T}} \\ {h}_{21} & {h}_{22} & … & {h}_{2 {N}_{T}} \\ ⋮ & & ⋱ & \\ {h}_{i 1} & {h}_{i 2} & … & {h}_{{iN}_{T}} \\ ⋮ & & ⋱ & \\ {h}_{{N}_{R} 1} & {h}_{{N}_{R} 2} & … & {h}_{{N}_{R} {N}_{T}}\end{matrix} ] \qquad [ Equation 8 ]$$

Additive white Gaussian noise (AWGN) is added to an actual channel which has passed the channel matrix H shown in Equation 8. The AWGN n₁, n₂, . . . , n_{NR} added to each of N_{R} Rx antennas can be represented by a specific vector shown in the following equation 9.

n=[n₁,n₂, . . . ,n_{N}_{_{R}}]^{T} [Equation 9]

A reception signal calculated by the above-mentioned equations can be represented by the following equation 10.

$$\begin{matrix}y = [ \begin{matrix}{y}_{1} \\ {y}_{2} \\ ⋮ \\ {y}_{i} \\ ⋮ \\ {y}_{{N}_{R}}\end{matrix} ] \\ = [ \begin{matrix}{h}_{11} & {h}_{12} & … & {h}_{1 {N}_{T}} \\ {h}_{21} & {h}_{22} & … & {h}_{2 {N}_{T}} \\ ⋮ & & ⋱ & \\ {h}_{i 1} & {h}_{i 2} & … & {h}_{{iN}_{T}} \\ ⋮ & & ⋱ & \\ {h}_{{N}_{R} 1} & {h}_{{N}_{R} 2} & … & {h}_{{N}_{R} {N}_{T}}\end{matrix} ] [ \begin{matrix}{x}_{1} \\ {x}_{2} \\ ⋮ \\ {x}_{j} \\ ⋮ \\ {x}_{{N}_{T}}\end{matrix} ] + [ \begin{matrix}{n}_{1} \\ {n}_{2} \\ ⋮ \\ {n}_{i} \\ ⋮ \\ {n}_{{N}_{R}}\end{matrix} ] \\ = Hx + n\end{matrix} \qquad [ Equation 10 ]$$

In the meantime, the number of rows and the number of columns of a channel matrix H indicating a channel condition are determined by the number of Tx/Rx antennas. In the channel matrix H, the number of rows is equal to the number (N_{R}) of Rx antennas, and the number of columns is equal to the number (N_{T}) of Tx antennas. Namely, the channel matrix H is denoted by an N_{R}×N_{T} matrix. Generally, a matrix rank is defined by a smaller number between the number of rows and the number of columns, in which the rows and the columns are independent of each other. Therefore, the matrix rank cannot be higher than the number of rows or columns. The rank of the channel matrix H can be represented by the following equation 11.

rank(H)≦min(N_{T},N_{R}) [Equation 11]

The rank may be defined as the number of non-zero Eigen values when Eigen value decomposition is performed on the matrix. Similarly, the rank may be defined as the number of non-zero singular values when singular value decomposition is performed on the matrix. Accordingly, the rank of the channel matrix refers to a maximum number of information pieces that can be transmitted on a given channel.

In description of the specification, ‘rank’ with respect to MIMO transmission indicates the number of paths through which signals can be independently transmitted at specific time in a specific frequency resource and ‘the number of layers’ refers to the number of signal streams transmitted through each path. Since a transmitting end transmits as many layers as the rank used in signal transmission, the rank corresponds to the number of layers unless otherwise mentioned.

Physical Uplink Control Channel (PUCCH)

Uplink control information (UCI) transmitted through a PUCCH may include a scheduling request (SR), HARQ ACK/NACK information and DL channel measurement information.

HARQ ACK/NACK information can be generated according to whether a DL data packet on a PDSCH has been successfully decoded. In a conventional wireless communication system, 1 bit is transmitted as ACK/NACK information for DL transmission of a single codeword and 2 bits are transmitted as ACK/NACK information for DL transmission of 2 codewords.

Channel measurement information refers to feedback information related to MIMO and may include a channel quality indicator (CQI), a precoding matrix index (PMI) and a rank indicator (RI). The channel measurement information may be commonly referred to as a CQI. 20 bits per subframe can be used for CQI transmission.

PUCCH can be modulated using binary phase shift keying (BPSK) and quadrature phase shift keying (QPSK). A plurality of pieces of UE control information may be transmitted through a PUCCH. When code division multiplexing (CDM) is performed in order to discriminate signals of UEs, a constant amplitude zero autocorrelation (CAZAC) sequence having a length of 12 is mainly used. Since the CAZAC sequence has a property that a constant amplitude is maintained in the time domain and in the frequency domain, a peak-to-average power ratio (PAPR) of a UE or cubic metric (CM) may be decreased to increase coverage. In addition, ACK/NACK information for DL data transmitted through the PUCCH may be covered using an orthogonal sequence or orthogonal cover (OC).

In addition, control information transmitted through the PUCCH may be discriminated using cyclically shifted sequences having different cyclic shift values. A cyclically shifted sequence may be generated by cyclically shifting a basic sequence (also called a base sequence) by a specific cyclic shift (CS) amount. The specific CS amount is indicated by a CS index. The number of available CSs may be changed according to channel delay spread. Various sequences may be used as the basic sequence and examples thereof include the above-described CAZAC sequence.

The quantity of control information that can be transmitted by a UE in a single subframe can be determined based on the number of SC-FDMA symbols (i.e. SC-FDMA symbols other than SC-FDMA symbols used to transmit a reference signal for detection of coherent of a PUCCH) available for control information transmission.

The PUCCH is defined in seven different formats according to transmitted control information, a modulation scheme, the quantity of control information, etc. Attributes of UCI transmitted according to PUCCH formats can be summarized as shown in Table 1.

TABLE 1

| | | Number of | | |
|---|---|---|---|---|
| PUCCH | Modulation | bits per | | |
| format | scheme | subframe | Usage | etc. |
| 1 | N/A | N/A | SR(Scheduling | |
| | | | Request) | |
| 1a | BPSK | 1 | ACK/NACK | One codeword |
| 1b | QPSK | 2 | ACK/NACK | Two codeword |
| 2 | QPSK | 20 | CQI | Joint Coding |
| | | | | ACK/NACK |
| | | | | (extended CP) |
| 2a | QPSK + | 21 | CQI + | Normal CP only |
| | BPSK | | ACK/NACK | |
| 2b | QPSK + | 22 | CQI + | Normal CP only |
| | BPSK | | ACK/NACK | |

PUCCH format 1 is used for SR transmission. Unmodulated waveforms are applied to SR transmission, which will be described in detail later.

PUCCH format 1a or 1b is used for ACK/NACK transmission. PUCCH format 1a or 1b can be used when HARQ ACK/NACK is transmitted alone in an arbitrary subframe. Otherwise, HARQ ACK/NACK and SR may be transmitted in the same subframe using UCCH format 1a or 1b.

PUCCH format 2 is used for CQI transmission and PUCCH 2a or 2b is used for transmission of CQI and HARQ ACK/NACK. PUCCH format 2 may be used for transmission of CQI and HARQ ACK/NACK in the case of extended CP.

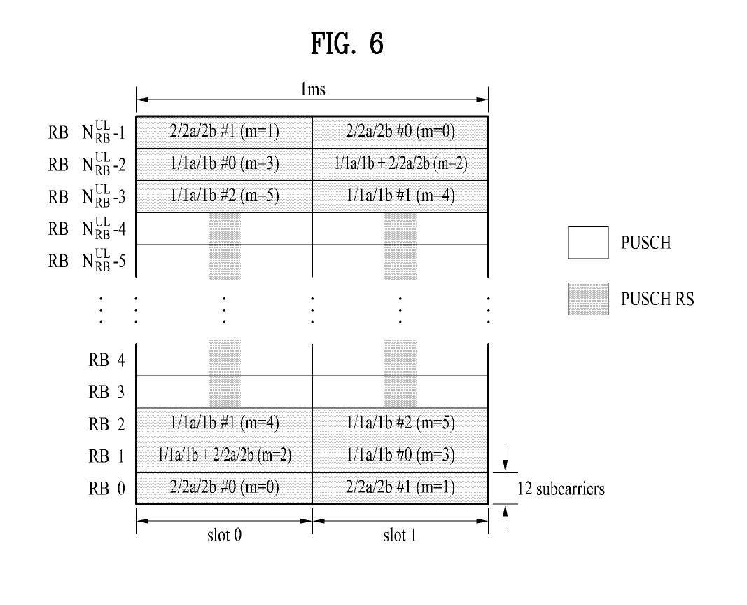

FIG. 6 illustrates mapping of PUCCH formats to PUCCH regions in a UL physical resource block. In FIG. 6, N_{RB}^{UL} denotes the number of resource blocks on uplink and 0, 1, . . . N_{RB}^{UL}−1 represent physical resource block numbers. The PUCCH is mapped to both edges of a UL frequency block. As shown in FIG. 6, PUCCH format 2/2a/2b is mapped to PUCCH regions indicated by m=0, 1, which represents that PUCCH format 2/2a/2b is mapped to resource blocks disposed at band-edges. PUCCH format 2/2a/2b and PUCCH format 1/1a/1b are mixed and mapped to PUCCH regions indicated by m=2. PUCCH format 1/1a/1b can be mapped to PUCCH regions indicated m=3, 4, 5. The number N_{RB}⁽²⁾ of PUCCH RBs that can be used by PUCCH format 2/2a/2b can be signaled to UEs in a cell through broadcast signaling.

PUCCH Resource

A UE is allocated a PUCCH resource for UCI transmission by a base station according to an explicit or implicit scheme through higher layer signaling.

In case of ACK/NACK, a plurality of PUCCH resource candidates may be configured for a UE by a higher layer and which one of the PUCCH resource candidates is used may be implicitly determined. For example, the UE can receive a PDSCH from a base station and transmit ACK/NACK for a corresponding data unit through a PUCCH resource implicitly determined by a PDCCH resource carrying scheduling information about the PDSCH.

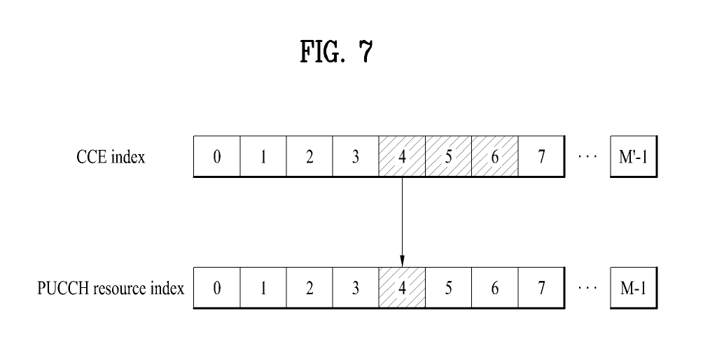

FIG. 7 illustrates an example of determining a PUCCH resource for ACK/NACK.

In LTE, a PUCCH that will carry ACK/NACK information is not allocated to a UE in advance. Rather, a plurality of PUCCHs is used separately at each time by a plurality of UEs within a cell. Specifically, a PUCCH that a UE will use to transmit ACK/NACK information is implicitly determined on the basis of a PDCCH carrying scheduling information for a PDSCH that delivers downlink data. An entire area carrying PDCCHs in a downlink subframe includes a plurality of control channel elements (CCEs) and a PDCCH transmitted to a UE includes one or more CCEs. A CCE includes a plurality of (e.g. 9) resource element groups (REGs). One REG includes four contiguous REs except for an RS. The UE transmits ACK/NACK information on an implicit PUCCH that is derived or calculated by a function of a specific CCE index (e.g. the first or lowest CCE index) from among the indexes of CCEs included in a received PDCCH.

Referring to FIG. 7, a PDCCH resource index corresponds to a PUCCH resource for ACK/NACK transmission. As illustrated in FIG. 7, on the assumption that a PDCCH including CCEs #4, #5 and #6 delivers scheduling information about a PDSCH to a UE, the UE transmits ACK/NACK to a BS on a PUCCH, for example, PUCCH #4 derived or calculated using the lowest CCE index of the PDCCH, CCE index 4. In the illustrated case of FIG. 7, there are up to M′ CCEs in a downlink subframe and up to M PUCCHs in an uplink subframe. Although M may be equal to M′, M may be different from M′ and CCEs may be mapped to PUCCHs in an overlapping manner. For instance, a PUCCH resource index may be calculated by the following equation.

n⁽¹⁾_{PUCCH}=n_{CCE}+N⁽¹⁾_{PUCCH} [Equation 15]

Here, n⁽¹⁾_{PUCCH} denotes the index of a PUCCH resource for transmitting ACK/NACK information, N⁽¹⁾_{PUCCH} denotes a signal value received from a higher layer, and n_{CCE} denotes the lowest of CCE indexes used for transmission of a PDCCH.

PUCCH Channel Structure

PUCCH formats 1a and 1b are described.

In the PUCCH format 1a/1b, a symbol modulated using BPSK or QPSK is multiplied by a CAZAC sequence of length 12. For example, when a modulated symbol d(0) is multiplied by a length-N CAZAC sequence r(n) (n=0, 1, 2, . . . , N−1), y(0), y(1), y(2), . . . , y(N−1) are obtained. Symbols y(0), y(1), y(2), . . . , y(N−1) may be called a block of symbols. Upon completion of the CAZAC sequence multiplication, the resultant symbol is blockwise-spread using an orthogonal sequence.

A Hadamard sequence of length 4 is applied to general ACK/NACK information, and a DFT (Discrete Fourier Transform) sequence of length 3 is applied to shortened ACK/NACK information and a reference signal. A Hadamard sequence of length 2 may be applied to the reference signal in an extended CP case.

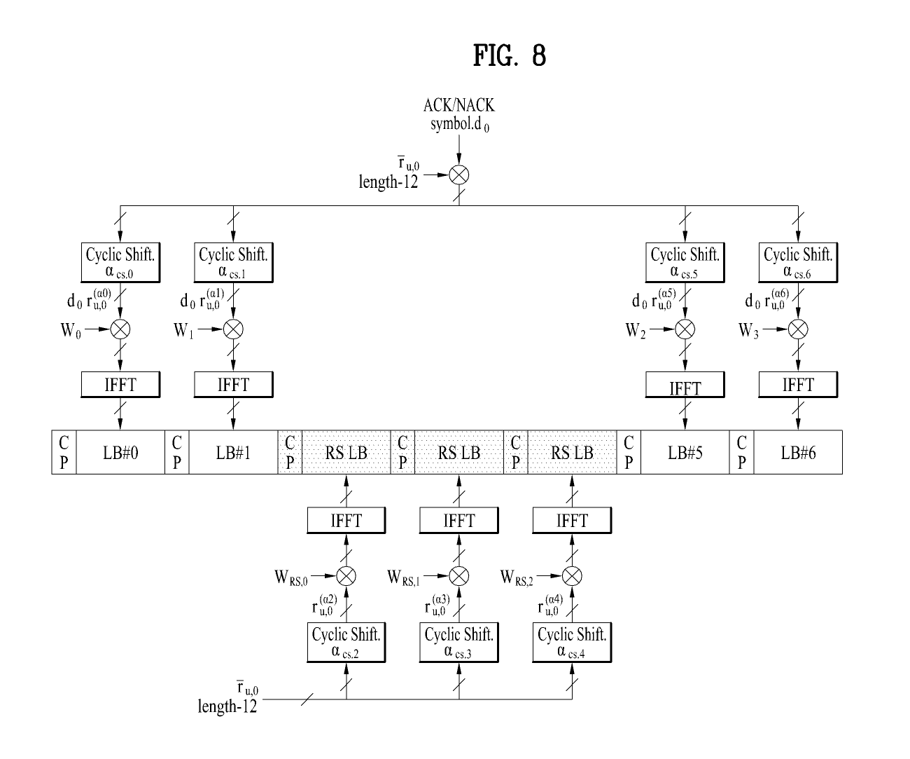

FIG. 8 illustrates an ACK/NACK channel structure in a normal CP case. FIG. 8 shows an exemplary PUCCH channel structure for HARQ ACK/NACK transmission without CQI. Three contiguous SC-FDMA symbols in the middle of seven SC-FDMA symbols carry an RS and the remaining four SC-FDMA symbols carry an ACK/NACK signal. In the case of the extended CP, two contiguous symbols in the middle of SC-FDMA symbols may carry an RS. The number and positions of symbols used for the RS may depend on a control channel and the number and positions of symbols used for the ACK/NACK signal may be changed according to the number and positions of symbols used for the RS.

1-bit ACK/NACK information and 2-bit ACK/NACK information (unscrambled) may be represented a HARQ ACK/NACK modulation symbol using BPSK and QPSK, respectively. ACK information may be encoded as ‘1’ and NACK information may be encoded as ‘0’.

When a control signal is transmitted in an allocated band, 2-dimensional spreading is applied to improve multiplexing capacity. That is, frequency domain spreading and time domain spreading are simultaneously applied to increase the number of UEs or control channels that can be multiplexed. To spread an ACK/NACK signal in the frequency domain, a frequency domain sequence is used as a basic sequence. A Zadoff-Chu (ZC) sequence, one type of CAZAC sequence, can be used as the frequency domain sequence. For example, different cyclic shifts (CSs) can be applied to a ZC sequence as a basic sequence to multiple different UEs or different control channels. The number of CS resources supported by SC-FDMA symbols for PUCCH RBs for HARQ ACK/NACK transmission is set by a cell-specific higher-layer signaling parameter Δ_{shift}^{PUCCH} and Δ_{shift}^{PUCCHε{}1, 2, 3} represents 12, 6 or 4 shifts.

The frequency-domain-spread ACK/NACK signal is spread in the time domain using an orthogonal spreading code. A Walsh-Hadamard sequence or a DFT sequence can be used as the orthogonal spreading code. For example, an ACK/NACK signal can be spread using a length-4 orthogonal sequence w0, w1, w2, w3. An RS is spread using a length-2 or length-2 orthogonal sequence. This is called orthogonal covering.

A plurality of UEs can be multiplexed through code division multiplexing (CDM) using CS resources in the frequency domain and OC resources in the time domain as described above. That is, ACK/NACK information and RSs of a large number of UEs can be multiplexed on the same PUCCH RB.

For time domain spreading CDM, the number of spreading codes supported for ACK/NACK information is limited by the number of RS symbols. That is, since the number of SC-FDMA symbols for RS transmission is smaller than the number of SC-FDMA symbols for ACK/NACK transmission, multiplexing capacity of an RS is less than multiplexing capacity of ACK/NACK information. For example, while ACK/NACK information can be transmitted through four symbols in the normal CP case, three orthogonal spreading codes are used for ACK/NACK information because the number of RS transmission symbols is limited to three and thus only three orthogonal spreading codes can be used for the RS.

Examples of an orthogonal sequence used to spread ACK/NACK information are shown in Tables 2 and 3. Table 2 shows a sequence for a length-4 symbol and Table 3 shows a sequence for a length-3 symbol. The sequence for the length-4 symbol is used in PUCCH format 1/1a/1b of a normal subframe configuration. Considering a case in which an SRS is transmitted on the last symbol of the second slot in a subframe configuration, the sequence for the length-4 symbol can be applied to the first slot and shortened PUCCH format 1/1a/1b of the sequence for the length-3 symbol can be applied to the second slot.

TABLE 2

| Sequence index | [w(0), w(1), w(2), w(3)] |
|---|---|
| 0 | [+1 +1 +1 +1] |
| 1 | [+1 −1 +1 −1] |
| 2 | [+1 −1 −1 +1] |

TABLE 3

| Sequence index | [w(0), w(1), w(2)] |
|---|---|
| 0 | [1 1 1] |
| 1 | [1 e^{j2π/3} e^{j4π/3}] |
| 2 | [1 e^{j4π/3} e^{j2π/3}] |

An exemplary orthogonal sequence used for RS spreading of an ACK/NACK channel is as shown in Table 4.

TABLE 4

| Sequence index | Normal CP | Extended CP |
|---|---|---|
| 0 | [1 1 1] | [1 1] |
| 1 | [1 e^{j2π/3} e^{j4π/3}] | [1 −1] |
| 2 | [1 e^{j4π/3} e^{j2π/3}] | N/A |

When three symbols are used for RS transmission and four symbols are used for ACK/NACK information transmission in a slot of a normal CP subframe, if six CSs in the frequency domain and three OC resources in the time domain can be used, for example, HARQ ACK/NACK signals from a total of 18 different UEs can be multiplexed in a PUCCH RB. When two symbols are used for RS transmission and four symbols are used for ACK/NACK information transmission in a slot of an extended CP subframe, if six CSs in the frequency domain and two OC resources in the time domain can be used, for example, HARQ ACK/NACK signals from a total of 12 different UEs can be multiplexed in a PUCCH RB.

PUCCH format 1 is described. A UE requests scheduling through a scheduling request (SR). An SR channel reuses an ACK/NACK channel structure in the PUCCH format 1a/1b and is configured in an on-off keying manner on the basis of ACK/NACK channel design. A reference signal is not transmitted on the SR channel. Accordingly, a length-7 sequence is used in the normal CP case and a length-6 sequence is used in the extended CP case. Different CSs or orthogonal covers may be allocated to an SR and ACK/NACK. That is, for positive SR transmission, a UE transmits HARQ ACK/NACK through a resource allocated for the SR. For negative SR transmission, the UE transmits HARQ ACK/NACK through a resource allocated for ACK/NACK.

The PUCCH format 2/2a/2b is will now be described. The PUCCH format 2/2a/2b is used to transmit channel measurement feedback (CQI, PMI and RI).

A channel measurement feedback (referred to as CQI hereinafter) reporting period and a frequency unit (or frequency resolution) corresponding to a measurement target can be controlled by a BS. Periodic and aperiodic CQI reports can be supported in the time domain. PUCCH format 2 can be used for the periodic report only and a PUSCH can be used for the aperiodic report. In the case of aperiodic report, the BS can instruct a UE to transmit an individual CQI report on a resource scheduled to transmit uplink data.

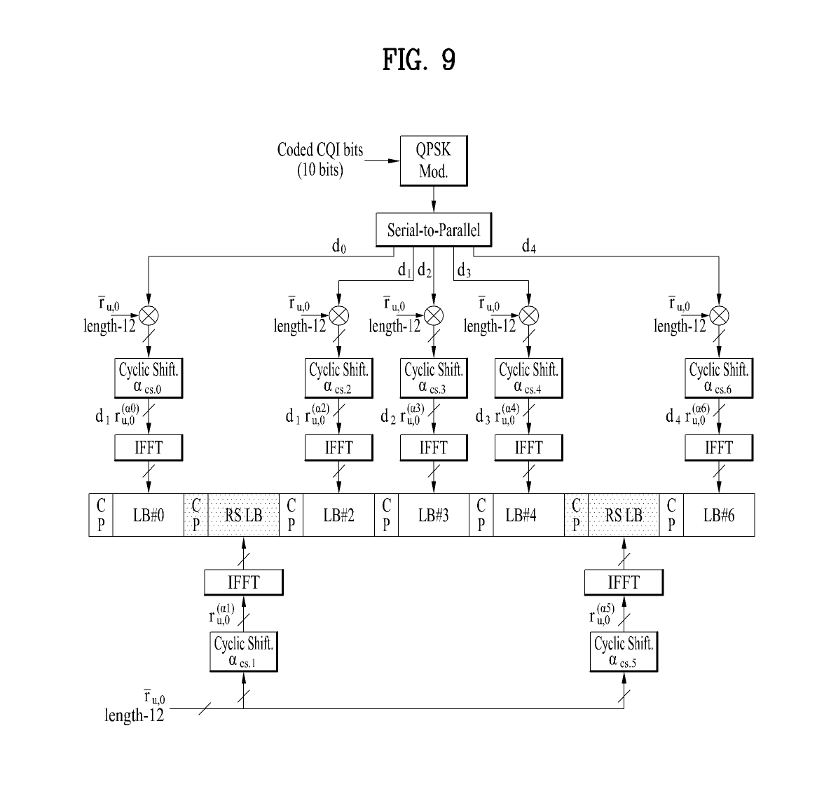

FIG. 9 illustrates a CQI channel structure in the case of normal CP. SC-FDMA symbols #1 to #5 (second and sixth symbols) from among SC-FDMA symbols #0 to #6 of a slot can be used for DMRS transmission and the remaining SC-FDMA symbols can be used for CQI transmission. In the case of extended CP, an SC-FDMA symbol (SC-FDMA symbol #3) is used for DMRS transmission.

The PUCCH format 2/2a/2b supports modulation by a CAZAC sequence and a symbol modulated according to QPSK is multiplied by a CAZAC sequence of length 12. A CS of the sequence is changed between symbols and between slots. Orthogonal covering is used for the DMRS.

Two SC-FDMA symbols having a distance therebetween, which corresponds to the interval of three SC-FDMA symbols, from among seven SC-FDMA symbols included in a slot carry a DMRS and the remaining five SC-FDMA symbols carry CQI. Two RSs are used in a slot in order to support a fast UE. Each UE is identified using a CS sequence. CQI symbols are modulated into SC-FDMA symbols and transmitted. The SC-FDMA symbols are composed of a sequence. That is, a UE modulates CQI into each sequence and transmits the sequence.

The number of symbols that can be transmitted in a TTI is 10 and modulation of CQI is performed using QPSK. When QPSK mapping is used for SC-FDMA symbols, an SC-FDMA symbol can carry 2-bit CQI and thus a slot can carry 10-bit CQI. Accordingly, a maximum of 20-bit CQI can be transmitted in a subframe. To spread CQI in the frequency domain, a frequency domain spreading code is used.

A length-12 CAZAC sequence (e.g. ZC sequence) can be used as the frequency domain spreading code. Control channels can be discriminated from each other using CAZAC sequences having different CS values. The frequency-domain-spread CQI is subjected to IFFT.

12 different UEs can be orthogonally multiplexed in the same PUCCH RB using 12 CSs at an equal interval. In the case of normal CP, while a DMRS sequence on SC-FDMA symbols #1 and #5 (SC-FDMA symbols #3 in the case of extended CP) is similar to a CQI signal sequence in the frequency domain, the DMRS sequence is not modulated. A UE can be semi-statically configured by higher layer signaling to periodically report different CQI, PMI and RI types on a PUCCH resource indicated by a PUCCH resource index n_{PUCCH}⁽²⁾. Here, the PUCCH resource index n_{PUCCH}⁽²⁾ is information indicating a PUCCH region and a CS value used for PUCCH format 2/2a/2b transmission.

An enhanced PUCCH (e-PUCCH) format will now be described. The e-PUCCH format may correspond to the PUCCH format 3 of LTE-A. Block spreading can be applied to ACK/NACK transmission using PUCCH format 3.

Block spreading is a method of modulating a control signal using SC-FDMA, distinguished from the PUCCH format 1 series or 2 series. As shown in FIG. 9, a symbol sequence can be spread in the time domain using an orthogonal cover code (OCC) and transmitted. Control signals of plural UEs can be multiplexed in the same RB using the OCC. A symbol sequence is transmitted in the time domain and control signals of multiple UEs are multiplexed using CSs of a CAZAC sequence in the above-described PUCCH format 2, whereas a symbol sequence is transmitted in the frequency domain and control signals of multiple UEs are multiplexed through time domain spreading using an OCC in the block spreading based PUCCH format (e.g. PUCCH format 3).

FIG. 10(a) illustrates an example of generating and transmitting four SC-FDMA symbols (i.e. data part) using a length-4 (or spreading factor (SF)=4) OCC in a symbol sequence during one slot. In this case, three RS symbols (i.e. RS part) can be used in one slot.

FIG. 10(b) illustrates an example of generating and transmitting five SC-FDMA symbols (i.e. data part) using a length-5 (or SF=5) OCC in a symbol sequence during one slot. In this case, two RS symbols can be used per slot.

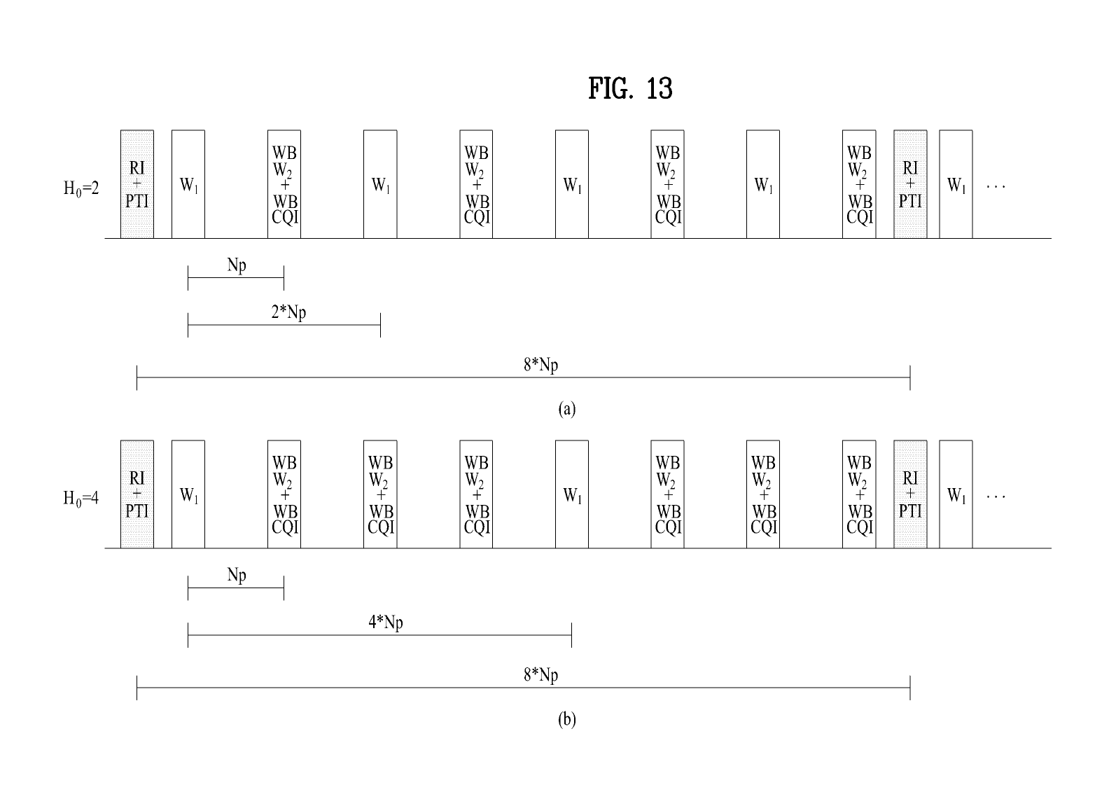

In the examples of FIG. 10, the RS symbols can be generated from a CAZAC sequence to which a specific CS value is applied, and a predetermined OCC can be applied to (or multiplied by) a plurality of RS symbols and transmitted. If 12 modulated symbols are used per OFDM symbol (or SC-FDMA symbol) and each modulated symbol is generated according to QPSK in the example of FIG. 13, a maximum of 12×2=24 bits can be transmitted in a slot. Accordingly, a total of 48 bits can be transmitted in two slots. When a block spreading based PUCCH channel structure is used as described above, it is possible to transmit an increased quantity of control information compared to the PUCCH format 1 series and 2 series.

Channel State Information (CSI)

MIMO may be classified into open loop and closed loop schemes. Open loop MIMO refers to MIMO transmission performed by a transmitter without CSI feedback of a MIMO receiver. Close loop MIMO refers to a scheme by which the transmitter receives CSI feedback from the MIMO receiver and performs MIMO transmission. According to closed loop MIMO, the transmitter and receiver can perform beamforming based on CSI to obtain a multiplexing gain of MIMO Tx antennas. The transmitter (e.g. BS) may allocate a UL control channel or UL shared channel to the receiver (e.g. UE) such that the receiver (e.g. UE) can feed back CSI.

The CSI may include RI, PMI and CQI.

RI is information regarding a channel rank which indicates the number of layers (or streams) capable of transmitting different pieces of information through the same time-frequency resource. Since a rank value is determined according to long term fading of a channel, RI can be fed back in a long period (i.e. less frequently) compared to PMI and CQI.

PMI is information regarding a precoding matrix used for data transmission of a transmitter. Precoding refers to mapping of a transport layer to a Tx antenna and layer-antenna mapping relationship may be determined by a precoding matrix. PMI corresponds to a precoding matrix index of a preferred BS of a UE on the basis of metrics such as a signal-to-interference plus noise ratio (SINR). To reduce precoding information feedback overhead, the transmitter and receiver may share a codebook including various precoding matrices and only an index indicating a specific precoding matrix in the codebook may be fed back.

CQI is information regarding channel quality or channel intensity. CQI may be represented by a predetermined MCS combination. That is, a fed back CQI index represents a corresponding modulation scheme and code rate. In general, CQI is a value reflecting reception SINR that can be obtained when a BS configures a spatial channel using PMI.

A system (e.g. LTE-A) supporting extended antenna configuration considers acquisition of additional multi-user diversity using multi-user MIMO (MU-MIMO). In MU-MIMO, an interference channel is present between UEs multiplexed in an antenna domain, and thus it is necessary to prevent generation of interference in a UE when a BS performs DL transmission using CSI fed back from another UE from among multiple users. Accordingly, for correct MU-MIMO operation, CSI with high accuracy needs to be fed back as compared to single user MIMO (SU-MIMO).

For more accurate CSI measurement and reporting, a method of feeding back new CSI obtained by improving the conventional CSI composed of RI, PMI and CQI may be applied. For example, precoding information fed back by a receiver can be indicated by a combination of two PMIs. One (first PMI) of the two PMIs may have a long term and/or wideband property and may be referred to as W1 and the other may have a short term and/or subband property and may be referred to as W2. A final PMI can be determined by a combination (or function) of W1 and W2. For example, if the final PMI is W, then W=W1*W2 or W=W2*W1.

Here, W1 reflects frequency and/or time average characteristics of a channel. In other words, W1 may be defined as CSI that reflects long-term channel characteristics, wideband channel characteristics or long-term and wideband channel characteristics. To simply represent the characteristics of W1, W1 is referred to as long-term wideband CSI (or long-term wideband PMI) in the specification.

W2 reflects relatively instantaneous channel characteristics compared to W1. In other words, W2 may be defined as CSI that reflects short-term channel characteristics, subband channel characteristics or short-term and subband channel characteristics. To simply represent the characteristics of W2, W2 is referred to as short-term subband CSI (or short-term subband PMI) in the specification.

It is necessary to configure separate codebooks (i.e. a first codebook for W1 and a second codebook for W2) which are respectively composed of precoding matrices respectively representing two pieces of channel information (e.g. W1 and W2) having different attributes in order to determine a final precoding matrix W from the two pieces of channel information (e.g. W1 and W2). The codebooks configured in this manner may be referred to as hierarchical codebook. In addition, determination of a final codebook using the hierarchical codebooks may be referred to as hierarchical codebook transformation. When the hierarchical codebooks are used, channel feedback with high accuracy can be achieved compared to a case in which a single codebook is used. Single-cell MU-MIMO and/or multi-cell cooperative communication may be supported using channel feedback with high accuracy.

CSI Reporting

In a wireless communication system, a DL reception entity (e.g. UE) can measure reference signal received power (RSRP) of a reference signal transmitted on downlink, reference signal received quality (RSRQ), etc. at an arbitrary time and report a measurement result to a DL transmission entity (e.g. base station) in a periodic or event triggered manner. Each UE reports downlink channel information based on downlink channel state through uplink and the base station can determine an appropriate time/frequency resource and modulation and coding scheme (MCS) for data transmission per UE.

In case of the legacy 3GPP LTE system (e.g., 3GPP LTE Release-8 system), such channel information may be composed of a channel quality indicator (CQI), a precoding matrix indicator (PMI), and a rank indicator (RI). All or some of CQI, PMI and RI may be transmitted according to a transmission mode of each UE. In addition, such channel information reporting scheme may be divided into periodic reporting and aperiodic reporting upon receiving a request from the base station.

Each UE is set to aperiodic reporting using a CQI request bit having a predetermined size (e.g. I bit), which is included in uplink scheduling information transmitted from the base station to the UE. Each UE can transmit channel information considering a transmission mode thereof to the base station through a PUSCH upon reception of the information from the base station.

In case of periodic reporting, a cycle in which channel information is transmitted via a higher layer signal, an offset of the corresponding period, etc. may be signaled to each UE in units of a subframe, and channel information considering a transmission mode of each UE may be transmitted to the base station over a (PUCCH) at intervals of a predetermined time. When UL transmission data is present in a subframe in which channel information is transmitted at intervals of a predetermined time, the corresponding channel information may be transmitted together with data over a PUSCH rather than a PUCCH. In case of the periodic reporting over a PUCCH, a limited number of bits may be used as compared to PUSCH.

If periodic reporting collides with aperiodic reporting in the same subframe, only aperiodic reporting may be performed.

In order to calculate a WB CQI/PMI, the most recently transmitted RI may be used. In a PUCCH reporting mode, RI may be independent of another RI for use in a PUSCH reporting mode. RI is valid only for CQI/PMI for use in the corresponding PUSCH reporting mode.

The CQI/PMI/RI feedback type for the PUCCH reporting mode may be classified into four feedback types. Type 1 is CQI feedback for a user-selected subband. Type 2 is WB CQI feedback and WB PMI feedback. Type 3 is RI feedback. Type 4 is WB CQI feedback.

Referring to Table 5, in the case of periodic reporting of channel information, a reporting mode is classified into four reporting modes 1-0, 1-1, 2-0 and 2-1) according to CQI and PMI feedback types.

TABLE 5

| | | PMI Feedback Type | |
|---|---|---|---|
| | | No PMI (OL, TD, single-antenna) | Single PMI (CL) |
| CQI | Wideband | Mode 1-0 | Mode 1-1 |
| Feedback | | RI (only for Open-Loop SM) | RI |
| Type | | One Wideband CQI (4 bit) | Wideband CQI (4 bit) |
| | | | Wideband spatial CQI (3 bit) for RI > 1 |
| | | when RI > 1, CQI of first codeword | Wideband PMI (4 bit) |
| | UE | Mode 2-0 | Mode 2-1 |
| | Selected | RI (only for Open-Loop SM) | RI |
| | | Wideband CQI (4 bit) | Wideband CQI (4 bit) |
| | | Best-1 CQI (4 bit) in each BP | Wideband spatial CQI (3 bit) for RI > 1 |
| | | Best-1 indicator(L-bit label) | Wideband PMI (4 bit) |
| | | | Best-1 CQI (4 bit) 1 in each BP |
| | | when RI > 1, CQI of first codeword | Best-1 spatial CQI (3 bit) for RI > 1 |
| | | | Best-1 indicator (L-bit label) |

The reporting mode is classified into a wideband (WB) CQI and a subband (SB) CQI according to a CQI feedback type. The reporting mode is classified into a No-PMI and a single PMI according to transmission or non-transmission of PMI. As can be seen from Table 5, ‘NO PMI’ may correspond to an exemplary case in which open loop (OL), transmit diversity (TD), and a single antenna are used, and ‘single PMI” may correspond to an exemplary case in which closed loop (CL) is used.

Mode 1-0 may indicate an exemplary case in which PMI is not transmitted and only WB CQI is transmitted. In case of Mode 1-0, RI may be transmitted only in the case of OL spatial multiplexing (SM), and one WB CQI denoted by 4 bits may be transmitted. If RI is higher than ‘1’, CQI for a first codeword may be transmitted. In Mode 1-0, feedback type 3 and feedback type 4 may be multiplexed at different time points within the predetermined reporting period, and then transmitted (this may be referred to as time division multiplexing (TDM)-based channel information transmission).

Mode 1-1 may indicate an exemplary case in which a single PMI and a WB CQI are transmitted. In this case, 4-bit WB CQI and 4-bit WB PMI may be transmitted simultaneously with RI transmission. In addition, if RI is higher than ‘1’, 3-bit WB spatial differential CQI may be transmitted. In case of transmission of two codewords, the WB spatial differential CQI may indicate a differential value between a WB CQI index for codeword 1 and a WB CQI index for codeword 2. These differential values may be assigned to the set {−4, −3, −2, −1, 0, 1, 2, 3}, and each differential value may be assigned to any one of values contained in the set and be represented by 3 bits. In case of Mode 1-1, feedback type 2 and feedback type 3 may be multiplexed at different time points within the predetermined reporting period, and then transmitted.

Mode 2-0 may indicate that no PMI is transmitted and CQI of a UE-selected band is transmitted. In this case, RI may be transmitted only in case of open loop spatial multiplexing (OL SM), and a WB CQI denoted by 4 bits may be transmitted. In each bandwidth part (BP), best-1 CQI may be transmitted. Best-1 CQI may be denoted by 4 bits. In addition, an indicator of L bits indicating best-1 may be further transmitted. If RI is higher than ‘1’, CQI for a first codeword may be transmitted. In case of Mode 2-0, the above-mentioned feedback type 1, feedback type 3, and feedback type 4 may be multiplexed at different time points within a predetermined reporting period, and then transmitted.

Mode 2-1 may indicate an exemplary case in which a single PMI and CQI of a UE-selected band are transmitted. In this case, WB CQI of 4 bits, WB spatial differential CQI of 3 bits, and WB PMI of 4 bits are transmitted simultaneously with RI transmission. In addition, best-1 CQI of 4 bits and a best-1 indicator of L bits may be simultaneously transmitted at each bandwidth part (BP). If RI is higher than ‘1’, best-1 spatial differential CQI of 3 bits may be transmitted. During transmission of two codewords, a differential value between a best-1 CQI index of codeword 1 and a best-1 CQI index of codeword 2 may be indicated. In Mode 2-1, the above-mentioned feedback type 1, feedback 2, and feedback type 3 may be multiplexed at different time points within a predetermined reporting period, and then transmitted.

For more accurate CSI feedback in an advanced wireless communication system, a precoding matrix may be determined according to a combination of two PMIS, as described above. A description will be given of PUCCH reporting modes applicable in this case.

When a multi-unit precoder indicator (i.e. W1 and W2) is reported to the base station, different feedback modes can be indicated using a precoder type indicator (PTI) bit.

In a feedback mode, RI, W1 and W2/CQI are transmitted in different subframes and W1, W2 and CQI are set to WB information. In another feedback mode, W2 and CQI are reported with the same subframe granularity of W2/CQI corresponds to WB or SB according to reported subframe. That is, feedback modes as shown in Table 6 can be defined. PUCCH reporting modes shown in Table 6 may be considered as advanced forms of PUCCH reporting mode 2-1 of FIG. 5.

TABLE 6

| Report 1 | Report 2 | Report 3 |
|---|---|---|
| RI + | Wideband W1 | Wideband W2 + |
| PTI = 0 | | Wideband CQI |
| RI + | Wideband W2 + | Subband W2 + |
| PTI = 1 | Wideband CQI | Subband CQI |

In Table 6, Report 1, Report 2 and Report 3 represent information reported at a CSI reporting timing. That is, one of Report 1, Report 2 and Report 3 can be reported at a CSI reporting timing.

When PTI is 0 in Table 6, RI and PTI may be transmitted in Report 1, WB W1 may be transmitted at an arbitrary time (Report 2), and then WB W2 and WB CQI may be transmitted at an arbitrary time (Report 3). In addition, WB W1 may be reported in a predetermined period within RI reporting period and WB W2 and WB CQI may be reported at the remaining CSI reporting timing.

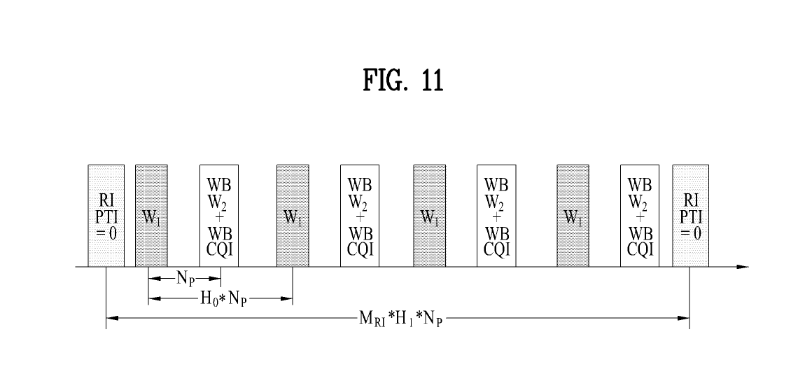

FIG. 11 illustrates a feedback structure according to PUCCH reporting mode 2-1 in case of PTI=0.

As shown in FIG. 11, it can be assumed that CSI is reported at intervals of Nₚ subframes (i.e. Nₚ ms). This means that a predetermined reference period in which CSI is reported corresponds to Nₚ subframes irrespective of types of WB W2 and WB PMI/CQI. Report 2 (i.e. WB W1 report) is transmitted in a subframe that satisfies the following equation 12.

(10×n_{f}+└nₛ/2┘−N_{OFFSET})mod(H·N_{P})=0 [Equation 12]

In Equation 12, n_{f} is a subframe number, nₛ is a slot number and N_{OFFSET} represents a relative offset with respect to Report 2 (i.e. WB W1 report) and Report 3 (i.e. WB W2 and WB CQI report). As can be seen from Equation 12, Report 2 has a period of H*N_{P} and H for PTI=0 is determined by a higher layer signal (H applied to a case of PTI=0 can be represented as H₀). In addition, Report 3 may be reported (H-1 times) at CSI reporting timing between two consecutive Report 2s. FIG. 11 shows an exemplary case in which H=2.

When PTI is 1 in Table 6, RI and PTI may be transmitted in Report 1, WB W1 and WB CQI may be transmitted at an arbitrary time (Report 2), and then SB W2 and SB CQI may be transmitted at an arbitrary time (Report 3).

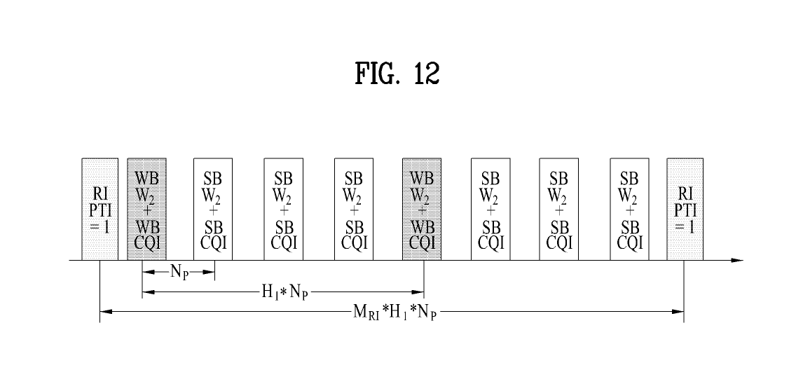

FIG. 12 illustrates a feedback structure according to PUCCH reporting mode 2-1 in case of PTI=1.

As shown in FIG. 12, it is assumed that the CSI reporting period is Nₚ subframes. Report 2 (i.e. WB W2 and WB CQI report) is transmitted in a subframe that satisfies Equation 12. Here, H in case of PTI=1 is defined as the following equation 13.

H=J·K+1 [Equation 13]

In Equation 13, J denotes the number of bandwidth parts and K is provided by a higher layer. If H applied to a case of PTI=1 is H₁, Report 2 has a period of H₁*N_{P} (=(J*K+1)*N_{P}). In addition, Report 3 may be reported at J*K CSI reporting timings between two consecutive Report 2. FIG. 12 shows an exemplary case in which J=3 and K=1.

A Report 1 (RI and PTI) reporting period is defined as an integer multiple (M_{RI}) of a WB PMI/CQI reporting period when PTI=1. That is, the RI reporting period is defined as H*N_{P}*M_{RI} (that is, H₁*N_{P}*M_{RI}=(J*K+1)*N_{P}*M_{RI}) in both cases of PTI=0 and PTI=1. In addition, RI reporting timing may be determined according to a predetermined offset N_{OFFSET,RI} based on WB PMI/CQI reporting timing. Accordingly, RI can be reported in a subframe that satisfies the following equation 14.

(10×n_{f}+└nₛ/2┘−N_{OFFSET}−N_{OFFSET,RI})mod(H₁·N_{P}·M_{RI})=0 [Equation 14]

Improved CSI Reporting Scheme

In periodic CQI reporting, CSI to be transmitted may be determined/calculated on the basis of most recently transmitted CSI. In other words, CSI to be transmitted has dependency on previously reported information. For example, when PUCCH reporting mode 2-1 (refer to Table 6) is applied and PTI=0, WB W2 and WB CQI are determined/calculated on the basis of most recently reported W1. In the example as shown in FIG. 11, WB W2 and WB CQI reports can be determined/calculated based on most recently reported W1.

CSI on which another CSI piece that needs to be determined/calculated depends may not be reported. For example, a CQI reported along with W2 is calculated on the assumption that a precoding matrix determined by W2 reported along with the same and previously reported Wlis applied. However, when W1 is not reported prior to the CQI and W2, W2 or CQI cannot be correctly calculated since information on which calculation of W2 or CQI is based is not present. It can be assumed that a previous channel state suitable for rank-1 transmission is changed to a current channel state suitable for rank-2 transmission. In this case, if W1 suitable for rank 2 is not reported after reporting of an RI for rank 2, then W2 and CQI suitable for rank 2 cannot be correctly determined/calculated. If W2 and CQI are determined/calculated on the basis of most recently reported W1, W2 and CQI cannot reflect the current channel state suitable for rank-2 transmission because the most recently reported W1 is suitable for previous rank-1 transmission, resulting in incorrect CSI reporting. Accordingly, when reporting of CSI that is a basis of determination/calculation of another CSI is dropped or is not performed, it is necessary to determine whether to report the corresponding CSI and information on which determination/calculation of CSI is based when the CSI is reported.

According to above-described definition of PUCCH reporting mode 2-1, an RI and PTI reporting period when PTI=0 has dependency on a WB W2 and WB CQI reporting period (H₁*Nₚ=(J*K+1)*Nₚ) when PTI=1. That is, the RI and PTI reporting period when PTI=0 is determined as M_{RI}*H₁*Nₚ=M_{RI}*(J*K+1)*Nₚ.

FIG. 13 illustrates an example of PUCCH reporting mode 2-1 according to H (i.e. H₀) when PTI=0. The example shown in FIG. 13 is based on the assumption that J=7, K=1 and M_{RI}=1. In this case, an RI reporting period is M_{RI}*H₁*Nₚ=1*(J*K+1)*Nₚ=8*Nₚ. That is, the RI and PTI are reported at interval of 8 reporting period (8*Nₚ) and W1 reporting or W2 and CQI reporting is performed at eight CSI transmission timings in the reporting period. The W1 reporting period is determined using H₀ signaled by a higher layer.

FIG. 13(a) shows a case in which H₀ is set to 2 by the higher layer. That is, W1 is reported at intervals of 2*Nₚ and WB W2 and WB CQI are reported at the remaining CSI reporting timings. Accordingly, W1 can be reported after RI/PTI reporting.

FIG. 13(b) shows a case in which H₀ is set to 4 by the higher layer. That is, W1 is reported at intervals of 4*Nₚ and WB W2 and WB CQI are reported at the remaining CSI reporting timings. Accordingly, W1 can be reported after RI/PTI reporting.

As described above, the RI and PTI reporting period is determined on the basis of the WB W2/CQI reporting period when PTI=1. Accordingly, the RI/PTI reporting period and W1 or W2/CQI reporting period are determined based on separately signaled values without being correlated with each other in PUCCH reporting mode 2-1 corresponding to PTI=0. That is, the RI/PTI reporting period is determined based on J and K corresponding to PTI=1 and W1 or W2/CQI reporting period is determined depending on H₀. Since J and K are not correlated with H₀, W2/CQI reporting may be performed instead of w1 reporting after RI/PTI reporting in PUCCH reporting mode 2-1 corresponding to PTI=O. In this case, determination/calculation of W2/CQI reported when W1 is not reported may not be correctly performed because information on which determination/calculation of W2/CQI is based is not decided. In particular, in the event that the RI is changed, correct determination/calculation of W2/CQI cannot be performed when W2/CQI is reported without reporting W1 suitable for the changed RI.

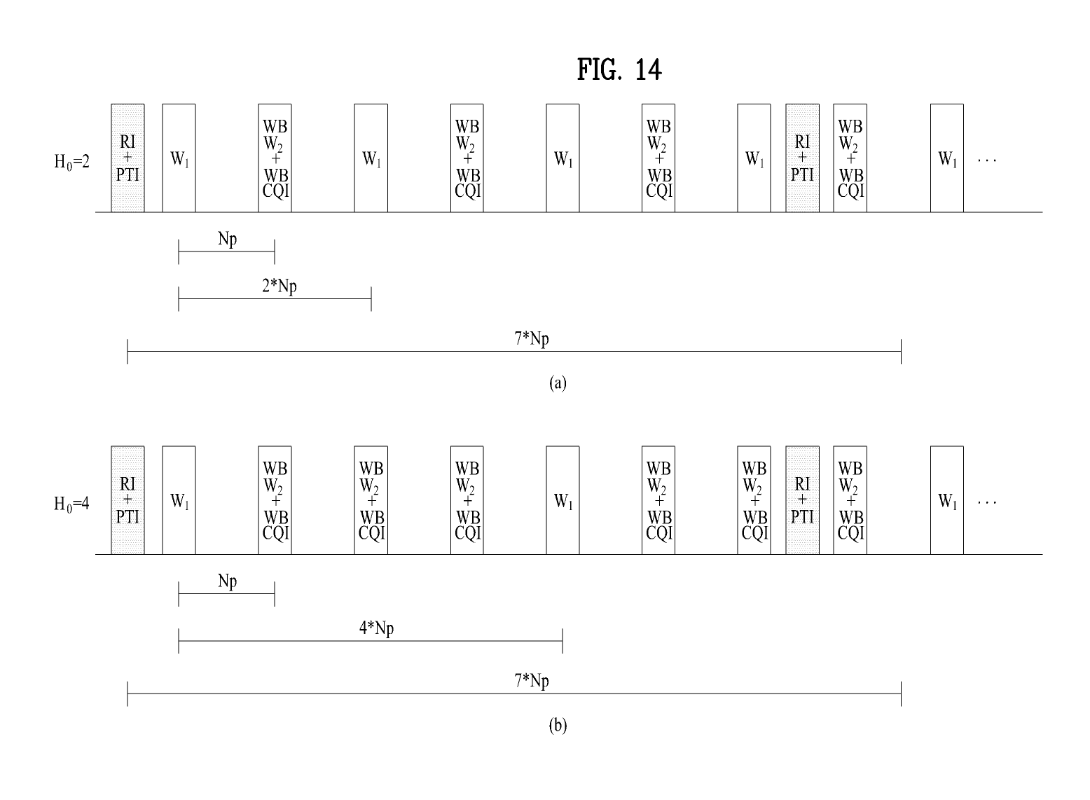

FIG. 14 illustrates another example of PUCCH reporting mode 2-1 according to He (i.e. H0) when PTI=0. The example shown in FIG. 13 is based on the assumption that J=3, K=2 and M_{RI}=1. In this case, the RI reporting period is M_{RI}*H₁*Nₚ=1*(J*K+1)*Nₚ=7*Nₚ. That is, RI and PTI are reported at an interval of 7 reporting periods (7*Nₚ) and W1 reporting or W2 and CQI reporting is performed at seven CSI transmission timings in the reporting period. The W1 reporting period is determined using H₀ signaled by the higher layer.

FIG. 14(a) shows a case in which H₀ is set to 2 by the higher layer. That is, W1 is reported at intervals of 2*Nₚ and WB W2 and WB CQI are reported at the remaining CSI reporting timings. In this case, W1 and W2/CQI are alternately reported in every Nₚ-th subframe. Accordingly, when W1 reporting follows first RI/PTI reporting, W2/CQI is reported after the next RI/PTI report.

FIG. 14(b) shows a case in which H₀ is set to 4 by the higher layer. That is, W1 is reported at intervals of 4*Nₚ and WB W2 and WB CQI are reported at the remaining CSI reporting timings. That is, a pattern in which W1 is reported once and W2/CQI is reported three times is repeated. In this case, when W1 reporting follows first RI/PTI reporting, W2/CQI is reported after the next RI/PTI report.

In the example shown in FIG. 14, it may be assumed that a rank value of 1 is reported through the first RI/PTI report and a changed rank value of 2 is reported through the second RI/PTI report. In this case, W2/CQI is reported without W1 reporting after the second RI/PTI report. According to the current PUCCH reporting scheme, the W2/CQI is determined/calculated on the basis of the most recently reported W1. The most recently reported W1 corresponds to W1 suitable for the rank value of 1 and is not suitable for the changed rank value of 2. Accordingly, when W2/CQI reporting is performed without W1 reporting after RI/PTI reporting, W2/CQI corresponds to invalid CSI since it is not determined/calculated based on the rank value suitable for the current channel. Furthermore, W1 reporting is not frequent and thus reliability of W1 reporting may be deteriorated.

Improved UCI Reporting Scheme

As described above, when the rank value of a previously reported RI is different from the rank value of a most recently reported RI (i.e. after RI is changed) in PUCCH reporting mode 2-1 for 8Tx transmission, W2/CQI may need to be reported while W1 is not reported. In this case, W2/CQI that needs to be calculated/determined can be referred to as invalid CSI due to rank mismatch. “Invalid CSI” in the present invention is not limited to the above-described example and can include any invalid CQI due to rank mismatch, such as first CQI when second CSI on which determination/calculation of the first CSI depends is based on a rank value different from a rank value assumed by the first CSI. However, a scheme of determining whether or not to report invalid CSI is not yet proposed.

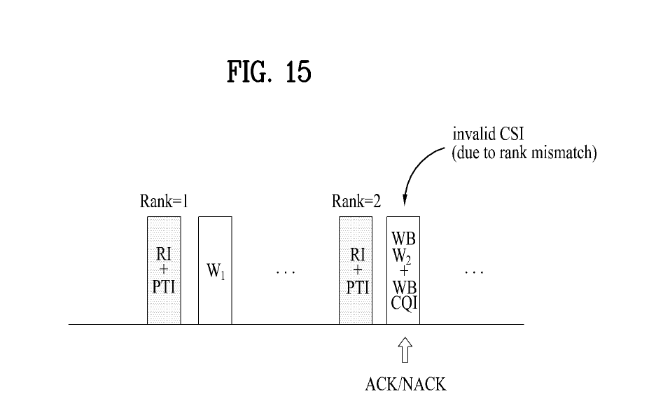

FIG. 15 illustrates exemplary CSI reporting timing and ACK/NACK reporting timing. As described above, timing of reporting CSI (i.e. RI, PMI, CQI, etc.) through a PUCCH can be determined based on a predetermined period. Timing of reporting ACK/NACK through a PUCCH can be determined according to a predetermined rule based on downlink data reception timing. In this manner, CSI transmission timing and ACK/NACK transmission timing are separately determined. Accordingly, CSI transmission timing and ACK/NACK transmission timing may overlap (that is, CSI and ACK/NACK may collide), as shown in FIG. 15.

In a conventional wireless communication system, a higher layer (e.g. RRC) can determine whether simultaneous transmission of CSI and ACK/NACK is permitted. For example, CSI (or CQI) and ACK/NACK can be simultaneously transmitted when a predetermined parameter (e.g. simultaneousAckNackandCQI) is set to “True” by the higher layer, whereas simultaneous transmission of CSI (or CQI) and ACK/NACK is not permitted when the predetermined parameter is set to “False”. In the case of simultaneousAckNackandCQI=True, CSI and ACK/NACK can be transmitted through PUCCH format 2a/2b in the normal CP case and joint-coded and transmitted through PUCCH format 2 in the extended CP case. In the case of simultaneousAckNackandCQI=False, CSI may be dropped and ACK/NACK can be transmitted since CSI and ACK/NACK collide.

When CSI is dropped in the event that ACK/NACK and CSI collide or it is determined that invalid CSI is not reported, CSI report dropping frequency may increase. In this case, a base station cannot correctly determine channel information necessary for downlink data transmission, and thus system performance may be deteriorated.

As described above, simultaneous transmission of CSI and ACK/NACK can be set by a higher layer. Here, when CSI to be transmitted is invalid CSI, UCI transmission cannot be correctly performed since a UCI transmission method in this case is not determined. Accordingly, the present invention provides a method for efficiently and correctly transmit/receive UCI by defining a UCI transmission scheme for a case in which invalid CIS and ACK/NACK are simultaneously transmitted.

When simultaneous transmission of CSI and ACK/NACK from a UE is set by a higher layer (e.g. simultaneousAckNackandCQI=True), the UE can determine whether to report the CSI when the CSI is invalid CSI due to rank mismatch. That is, the UE can report or drop the invalid CSI due to rank mismatch. Accordingly, the UE can perform one of the following four operations when the CSI and ACK/NACK need to be simultaneously transmitted.

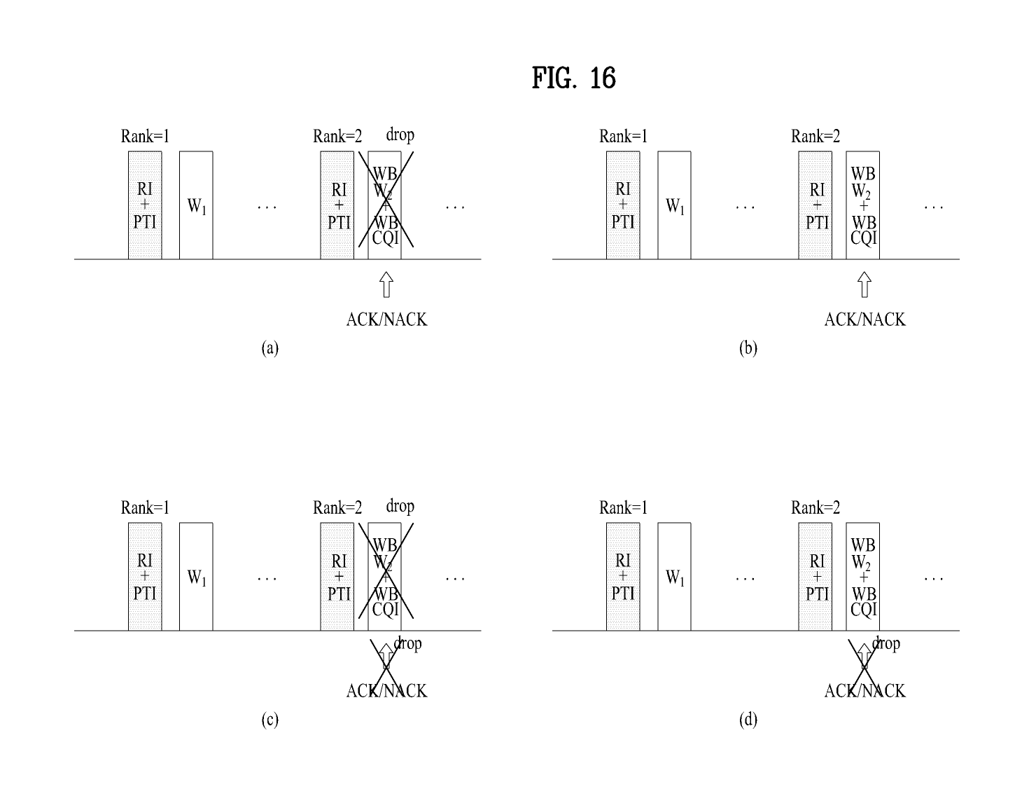

FIG. 16 illustrates transmission of invalid CSI and ACK/NACK according to embodiments of the present invention.

According to a second embodiment of the present invention, as shown in FIG. 16(b), the UE can transmit the CSI and ACK/NACK using PUCCH format 2/2a/2b without dropping the CSI.

According to a third embodiment of the present invention, as shown in FIG. 16(c), the UE can drop both CSI and ACK/NACK and transmit no information at the corresponding transmission timing.

According to a fourth embodiment of the present invention, as shown in FIG. 16(d), the UE can drop the ACK/NACK and transmit the CSI using PUCCH format 2.

The ACK/NACK is dropped in the third and fourth embodiments. When the ACK/NACK is dropped, the base station can perform retransmission of previously transmitted downlink data upon recognizing that the UE has not successfully decoded the downlink data. This is a correct operation when the UE has not actually decoded the downlink data. However, when the UE drops ACK although the UE should correctly decode the downlink data and report the ACK, the UE needs to unnecessarily schedule a downlink resource and retransmit the downlink data to the base station. This may cause waste of resources. Retransmission of downlink data that need not be transmitted may deteriorate system performance rather than inappropriate downlink transmission due to incorrect estimation of downlink channel state by the base station owing to reporting of no CSI or reporting of invalid CSI. Therefore, it is desirable that ACK/NACK is not dropped if possible in the operation of the UE.

In the first and second embodiments, the CSI is dropped or not while the ACK/NACK is reported.

When the UE transmit CSI or not depending on whether the CSI is valid or invalid, operation complexity of the UE may increase. Accordingly, the second embodiment is advantageous for simplification of UE operation since the UE operates in the same manner as the conventional CSI and ACK/NACK transmission operation.

When it is more desirable that invalid CSI is not reported for system performance improvement or the UE has capability for the same, the UE can transmit only ACK/NACK without reporting invalid CSI due to rank mismatch as in the first embodiment. While the UE uses PUCCH format 2/2a/2b when simultaneously transmitting CSI and ACK/NACK as in the second embodiment, the UE can use PUCCH format 1a/1b or a newly defined PUCCH format (e.g. PUCHC format 3) for ACK/NACK transmission when transmitting only ACK/NACK as in the first embodiment.

When the UE determines whether to transmit CSI and/or ACK/NACK as described in the first to fourth embodiments, the base station cannot be aware of which one of PUCCH formats 1a/1b/2/2a/2b is used for the UE to transmit UCI and thus the base station can acquire UCI by performing blind decoding for all cases of transmission of CSI and ACK/NACK.

In the meantime, when ACK/NACK is scheduled to be transmitted at the timing of reporting invalid CSI due to rank mismatch, the UE may be configured to operate in a specific scheme to achieve more efficient UCI transmission/reception operations. For example, the UE can be configured to report CSI while dropping W2/CQI (i.e. invalid CSI) that may be recognized as incorrect information when the W2/CQI needs to be reported while W1 is not reported in the case of rank mismatch (e.g. when a previously reported RI is different from a most recently reported RI in PUCCH reporting mode 2-1 for 8Tx transmission). Accordingly, when CSI corresponding to invalid CSI due to rank mismatch and ACK/NACK need to be simultaneously transmitted, the UE can operate to drop the CSI and transmit only the ACK/NACK. ACK/NACK transmission can be performed using PUCCH format 1a/1b or a newly defined ACK/NACK transmission PUCCH format (e.g. PUCCH format 3). In this case, the base station can recognize that only the ACK/NACK is transmitted from the UE and acquire the ACK/NACK by detecting PUCCH format 1a/1b or newly defined ACK/NACK transmission PUCCH format (e.g. PUCCH format 3).

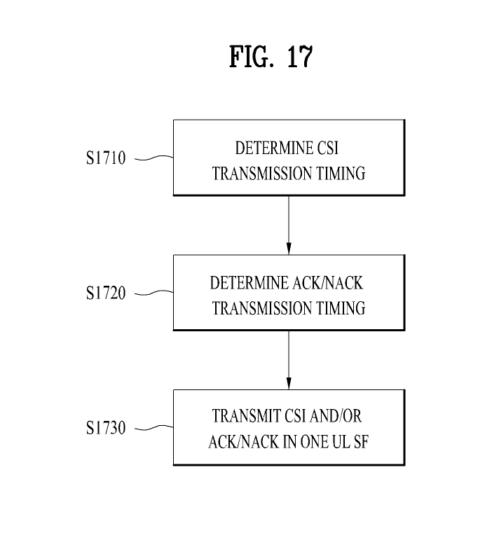

A description will be given of a method for transmitting UCI according to an embodiment of the present invention with reference to FIG. 17.

A UE may determine CSI transmission timing in step S1710. For example, in PUCCH reporting mode 2-1 for 8Tx transmission, RI reporting timing when PTI=0 can be determined on the basis of a multiple and offset of a wideband PMI/CQI reporting period corresponding to PTI=1 and wideband first PMI (W1) reporting timing and wideband second PMI (W2)/CQI reporting timing when PTI=0 can be determined on the basis of a higher layer parameter.

The UE may determine ACK/NACK transmission timing in step S1720. For example, ACK/NACK transmission timing for PDSCH transmission indicated by a PDCCH can be determined as an uplink subframe having an interval of k subframes (e.g. k=4) from subframe n in which the PDCCH is received.

The UE may transmit one of or both the CSI and ACK/NACK in an uplink subframe in step S1730. If simultaneous transmission of the CSI and ACK/NACK is set, then the CSI and ACK/NACK can be simultaneously transmitted in one subframe. If the CSI is invalid CSI (e.g. invalid CSI due to rank mismatch), then the CSI can be dropped and only the ACK/NACK can be transmitted in the uplink subframe.

In the UCI transmission method according to the present invention, described with reference to FIG. 17, the above-described embodiments may be independently applied or two or more thereof may be simultaneously applied and redundant description is omitted for clarity.

The principle proposed by the present invention is equally applicable to channel state information feedback for MIMO transmission between a base station and a relay (on backhaul uplink and backhaul downlink) and MIMO transmission between a relay and a UE (on access uplink and access downlink).

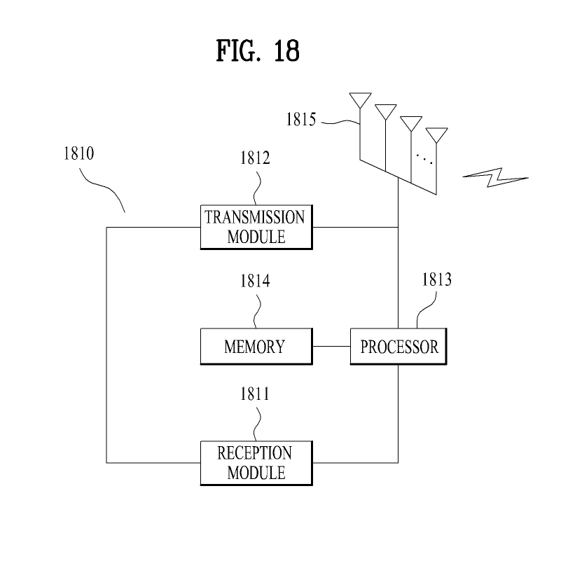

FIG. 18 illustrates a configuration of a transceiver according to an embodiment of the present invention.

Referring to FIG. 18, a transceiver 1810 according to an embodiment of the present invention may include a reception module 1811, a transmission module 1812, a processor 1813, a memory 1814 and a plurality of antennas 1815. The antennas 1815 refer to a transceiver supporting MIMO transmission/reception. The reception module 1811 may receive signals, data and information from an external device and the transmission module 1812 may transmit signals, data and information to the external device. The processor 1813 may control overall operation of the transceiver 1810.

The transceiver 1810 according to an embodiment of the present invention may be a UE that transmits UCI. The processor 1813 of the UE may be configured to determine CSI transmission timing and ACK/NACK information transmission timing. In addition, the processor 1813 may be configured to transmit one or both of CSI and ACK/NACK in an uplink subframe through the transmission module. Here, when the CSI is invalid CSI, the CSI can be dropped and only the ACK/NACK can be transmitted in the uplink subframe.

Furthermore, the processor 1813 of the transceiver 1810 may process information received by the transceiver 1810, information transmitted from the transceiver 1810 to the outside, etc. The memory 1814 may store processed information for a predetermined time and may be replaced by a component such as a buffer (not shown).

The transceiver may be configured such that the above-described various embodiments are independently applied or two or more thereof are simultaneously applied, and redundant description is omitted for clarity.

The above description of the base station may be equally applied to a relay corresponding to a downlink transmitting entity or an uplink reception entity and the description of the UE may be equally applied to a relay corresponding to a downlink reception entity or an uplink transmission entity.

The embodiments of the present invention may be achieved by various means, for example, hardware, firmware, software, or a combination thereof.

In a hardware configuration, the methods according to the embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present invention may be implemented in the form of a module, a procedure, a function, etc. For example, software code may be stored in a memory unit and executed by a processor. The memory unit is located at the interior or exterior of the processor and may transmit data to and receive data from the processor via various known means.

The detailed description of the preferred embodiments of the present invention is given to enable those skilled in the art to realize and implement the present invention. While the present invention has been described referring to the preferred embodiments of the present invention, those skilled in the art will appreciate that many modifications and changes can be made to the present invention without departing from the spirit and essential characteristics of the present invention. For example, the structures of the above-described embodiments of the present invention can be used in combination. The above embodiments are therefore to be construed in all aspects as illustrative and not restrictive. Therefore, the present invention is not intended to limit the embodiments disclosed herein but to give a broadest range matching the principles and new features disclosed herein.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein. Therefore, the present invention intends not to limit the embodiments disclosed herein but to give a broadest range matching the principles and new features disclosed herein. It is obvious to those skilled in the art that claims that are not explicitly cited in each other in the appended claims may be presented in combination as an embodiment of the present invention or included as a new claim by a subsequent amendment after the application is filed.

### INDUSTRIAL APPLICABILITY

The above-described method and apparatus for efficiently reporting CSI according to the above-described embodiments of the present invention are applicable to various mobile communication systems using multiple antennas.

1. A method for transmitting uplink control information (UCI) by user equipment (UE) in a wireless communication system, the method comprising:
determining timing of transmitting channel state information (CSI);
determining timing of transmitting acknowledgement/negative-acknowledgement (ACK/NACK) information; and
transmitting one or more of the CSI and ACK/NACK information through an uplink subframe,
wherein, when the CSI is invalid CSI, the CSI is dropped and only the ACK/NACK information is transmitted through the uplink subframe.

2. The method according to claim 1, wherein the UCI is transmitted using a physical uplink control channel (PUCCH).

3. The method according to claim 2, wherein PUCCH format 2a, 2b or 3 is used when the CSI is dropped and only the ACK/NACK information is transmitted.

4. The method according to claim 1, wherein the invalid CSI corresponds to a wideband second precoding matrix indicator (PMI) and wideband channel quality indicator (CQI) reported when a wideband first PMI is not reported after reporting of a rank indicator (RI) corresponding to a precoding type indicator (PTI) of 0.

5. The method according to claim 1, wherein a rank value in the RI reporting has been changed from a rank value in previous rank reporting.

6. The method according to claim 1, wherein the CSI is periodically reported.

7. The method according to claim 1, wherein simultaneous transmission of the CSI and ACK/NACK information is set by a higher layer for the UE.

8. A UE for reporting UCI in a wireless communication system, comprising:
a reception module for receiving a downlink signal from a base station;
a transmission module for transmitting an uplink signal to the base station; and
a processor for controlling the UE including the reception module and the transmission module,
wherein the processor is configured to determine timing of transmitting (CSI), to determine timing of transmitting ACK/NACK information and to transmit one or more of the CSI and ACK/NACK information through an uplink subframe,
wherein, when the CSI is invalid CSI, the CSI is dropped and only the ACK/NACK information is transmitted through the uplink subframe.

9. The UE according to claim 8, wherein the UCI is transmitted using a PUCCH.

10. The UE according to claim 9, wherein PUCCH format 2a, 2b or 3 is used when the CSI is dropped and only the ACK/NACK information is transmitted.

11. The UE according to claim 8, wherein the invalid CSI corresponds to a wideband second PMI and wideband CQI reported when a wideband first PMI is not reported after reporting of an RI corresponding to a PTI of 0.

12. The UE according to claim 8, wherein a rank value in the RI reporting is changed from a rank value in previous rank reporting.

13. The UE according to claim 8, wherein the CSI is periodically reported.

14. The UE according to claim 8, wherein simultaneous transmission of the CSI and ACK/NACK information is set by a higher layer for the UE.
